(19) United States
(12) Patent Application Publication
(10) Pub. No.: US 2025/0345756 A1
(43) Pub. Date: Nov. 13, 2025

(54) MEMBRANE-BASED SEPARATION OF MICELLE-ASSOCIATED PFAS MOLECULES

(71) Applicant: Gradiant Corporation, Woburn, MA (US)

(72) Inventors: Steven Lam, Singapore (SG); Ming Feng Tay, Singapore (SG); Wai Ren Keng, Jurong West (SG)

(73) Assignee: Gradiant Corporation, Woburn, MA (US)

(21) Appl. No.: 19/203,606

(22) Filed: May 9, 2025

Related U.S. Application Data
(60) Provisional application No. 63/645,798, filed on May 10, 2024.

(51) Int. Cl. B01D 71/36; B01D 61/24; B01D 61/38

(52) U.S. Cl. CPC B01D 71/36; B01D 61/246; B01D 61/38; B01D 2323/216; B01D 2323/21839

(57) ABSTRACT

Certain aspects of the present disclosure are related to systems and methods related to the removal of PFAS molecules. In one aspect, systems comprising a membrane separator and a foam fractionation separator are generally described. In some embodiments, the membrane separator and the foam fractionation separator are fluidically connected such that some or all of a feed comprising PFAS molecules, a surfactant, and a liquid and/or a foam fractionation separator input comprising PFAS molecules and a liquid can be processed by the membrane separator and/or the foam fractionation separator. In some embodiments, at least a portion of the PFAS molecules are removed from the feed and/or the foam fractionation separator input. In some embodiments, the surfactant is present such that some or all of the PFAS molecules are associated with micelles, which may facilitate the removal of the PFAS molecules from the feed and/or the foam fractionation separator input. In some embodiments, the membrane separator rejects PFAS molecules (e.g., associated with micelles) to a greater extent than certain dissolved ions.

### RELATED APPLICATIONS

This application claims priority under 35 U.S.C. § 119(e) to U.S. Provisional Patent Application No. 63/645,798, filed May 10, 2024, and entitled “Membrane-Based Separation of Micelle-Associated PFAS Molecules,” which is incorporated herein by reference in its entirety for all purposes.

### TECHNICAL FIELD

Systems and methods for the removal of per- and/or polyfluoroalkyl substances (PFAS) are generally described.

### BACKGROUND

Per- and/or polyfluoroalkyl substances (PFAS) pose health and environmental problems. Therefore, improved methods and related systems for treating PFAS-containing mixtures are desirable.

### SUMMARY

Systems and methods for the removal of per- and/or polyfluoroalkyl substances (PFAS) are generally described. The subject matter of the present disclosure involves, in some cases, interrelated products, alternative solutions to a particular problem, and/or a plurality of different uses of one or more systems and/or articles.

In one aspect, systems for the removal of per- and/or polyfluoroalkyl substances (PFAS) are provided.

In some embodiments, the system comprises: a membrane separator comprising at least one semi-permeable membrane defining a permeate side of the membrane separator and a retentate side of the membrane separator, wherein the retentate side of the membrane separator is configured to receive a membrane separator retentate input comprising per- and/or polyfluoroalkyl substance (PFAS) molecules, a liquid, and a surfactant; and a foam fractionation separator, comprising: an inlet fluidically connected to the permeate side of the membrane separator and configured to receive a foam fractionation separator input; one or more outlets configured to: output a foam fractionated product output having a lower concentration of the PFAS molecules than the foam fractionation separator input, and output a foam fractionated recovery output, the foam fractionated recovery output comprising at least some of the PFAS molecules and at least some of the surfactant.

In some embodiments, the system comprises: a membrane separator comprising at least one semi-permeable membrane defining a permeate side of the membrane separator and a retentate side of the membrane separator, wherein the retentate side of the membrane separator is configured to receive a membrane separator retentate input comprising at least a portion of a foam fractionated recovery output comprising per- and/or polyfluoroalkyl substance (PFAS) molecules, a liquid, and a surfactant; and a foam fractionation separator, comprising: one or more inlets configured to: receive a foam fractionation separator input; and one or more outlets configured to: output a foam fractionated product output having a lower concentration of the PFAS molecules than the foam fractionation separator input, and output the foam fractionated recovery output.

In some embodiments, the system comprises: a membrane separator comprising at least one semi-permeable membrane and configured to: receive a membrane separator retentate input comprising per- and/or polyfluoroalkyl substance (PFAS) molecules, a surfactant, and a liquid; and remove at least a portion of the PFAS molecules from the membrane separator retentate input.

In another aspect, methods for the removal of per- and/or polyfluoroalkyl substances (PFAS) are provided.

In some embodiments, the method comprises removing an amount of per- and/or polyfluoroalkyl substance (PFAS) molecules from a feed comprising a liquid and the PFAS molecules, wherein the removing comprises: transporting a membrane separator retentate input to a retentate side of a membrane separator, the membrane separator retentate input comprising at least a portion of the feed and a surfactant present such that at least some of the PFAS molecules are associated with a micelle comprising the surfactant, such that: a membrane separator retentate output exits the retentate side of the membrane separator, and at least a portion of liquid from the membrane separator retentate input is transported from the retentate side of the membrane separator, through a semi-permeable membrane of the membrane separator, to a permeate side of the membrane separator to form some or all of a membrane separator permeate output having a concentration of PFAS molecules that is less than a concentration of PFAS molecules in the membrane separator retentate input; wherein the membrane separator retentate input comprises at least a portion of the membrane separator retentate output, which comprises at least some of the PFAS molecules transported to the retentate side of the membrane separator.

In some embodiments, the method comprises contacting a membrane separator retentate input comprising a liquid and per- and/or polyfluoroalkyl substance (PFAS) molecules associated with a micelle comprising a surfactant with a semi-permeable membrane, such that at least a portion of the PFAS is removed from the liquid and a membrane separator retentate output is formed.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is a schematic diagram depicting a system comprising a foam fractionation separator and a membrane separator, according to some embodiments.

FIG. 1B is a schematic diagram showing a system comprising a foam fractionation separator and a membrane separator receiving at least a portion of a foam fractionated recovery output, according to some embodiments.

FIG. 1C is a schematic diagram showing a system comprising a foam fractionation separator, a membrane separator, and a vessel, according to some embodiments.

FIG. 1D is a schematic diagram showing a system comprising a foam fractionation separator, a membrane separator, and a vessel receiving at least a portion of a foam fractionated recovery output, according to some embodiments.

FIG. 2A is a schematic diagram showing a system comprising a foam fractionation separator, receiving a foam fractionation input, and a membrane separator receiving at least a portion of a foam fractionated recovery output, according to some embodiments.

FIG. 2B is a schematic diagram showing a system comprising a foam fractionation separator receiving a foam fractionation input, a vessel receiving at least a portion of a foam fractionated recovery output and at least a portion of a membrane separator retentate output, and a membrane separator, according to some embodiments.

FIG. 3 is a schematic diagram showing a system comprising a membrane separator receiving a membrane separator retentate input comprising at least a portion of a feed and at least a portion of a membrane separator retentate output, according to some embodiments.

FIG. 4A is a schematic diagram depicting a membrane separator comprising a single semi-permeable membrane, according to some embodiments.

FIG. 4B is a schematic diagram depicting three semi-permeable membranes fluidically connected in parallel, according to some embodiments.

FIG. 4C is a schematic diagram depicting three semi-permeable membranes fluidically connected in series, according to some embodiments.

FIG. 5 is a schematic diagram depicting a membrane separator configured to receive an input comprising cationic surfactant, according to some embodiments.

FIG. 6 is a schematic diagram depicting a membrane separator configured to recycle and/or reject at least a portion of a membrane separator retentate output, according to some embodiments.

FIG. 7 is a schematic diagram depicting a membrane separator in fluidic communication with a vessel (e.g., EQ tank), according to some embodiments.

FIG. 8 is a schematic diagram depicting a system comprising a foam fractionation separator upstream from a membrane separator, according to some embodiments.

FIG. 9 is a schematic diagram depicting a system comprising a foam fractionation separator downstream from a membrane separator, according to some embodiments.

FIG. 10 is a schematic diagram depicting two semi-permeable membranes fluidically connected in series via a membrane separator retentate output, according to some embodiments.

FIG. 11 is a schematic diagram depicting two semi-permeable membranes fluidically connected in series via a membrane separator permeate output, according to some embodiments.

FIG. 12 is a schematic diagram depicting two semi-permeable membranes fluidically connected in series such that an anionic surfactant is introduced prior to a first semi-permeable membrane and a cationic is introduced thereafter prior to a second semi-permeable membrane, according to some embodiments.

FIG. 13A is a plot depicting the logarithmic trendline-fit rejection percentages of perfluorobutanoic acid (PFBA) by a semi-permeable membrane at varying surfactant concentrations, according to some embodiments.

FIG. 13B is a plot depicting the logarithmic trendline-fit rejection percentages of sulfate by a semi-permeable membrane at varying surfactant concentrations, according to some embodiments.

FIG. 13C is a plot depicting the logarithmic trendline-fit rejection percentages of perfluorononanoic acid (PFNA) by a semi-permeable membrane at varying surfactant concentrations, according to some embodiments.

FIG. 13D is a plot depicting the logarithmic trendline-fit rejection percentages of perfluorooctanoic acid (PFOA) by a semi-permeable membrane at varying surfactant concentrations, according to some embodiments.

FIG. 13E is a plot depicting the logarithmic trendline-fit rejection percentages of perfluorooctanesulfonic acid (PFOS) by a semi-permeable membrane at varying surfactant concentrations, according to some embodiments.

FIG. 13F is a plot depicting the logarithmic trendline-fit rejection percentages of perfluorobutanesulfonic acid (PFBS) by a semi-permeable membrane at varying surfactant concentrations, according to some embodiments.

FIG. 13G is a plot depicting the logarithmic trendline-fit rejection percentages of perfluorohexanesulphonic acid (PFHxS) by a semi-permeable membrane at varying surfactant concentrations, according to some embodiments.

### DETAILED DESCRIPTION

Certain aspects of the present disclosure are related to systems and methods related to the removal of PFAS molecules. In one aspect, systems comprising a membrane separator are generally described. In some embodiments, the system comprises the membrane separator and a foam fractionation separator. In some embodiments, the membrane separator and the foam fractionation separator are fluidically connected such that some or all of a feed comprising PFAS molecules and a liquid can be processed by the membrane separator and/or the foam fractionation separator. In some embodiments, at least a portion of the PFAS molecules are removed from the membrane separator retentate input and/or the foam fractionation separator input. In some embodiments, the surfactant is present such that some or all of the PFAS molecules are associated with micelles, which may facilitate the removal of the PFAS molecules from the feed and/or the foam fractionated separator input.

Per- and/or polyfluoroalkyl substance (PFAS) molecules are known to have contaminated portions of the environment, including water sources for agricultural applications, industrial applications, and consumption. For purposes of clarity, “PFAS” will be used herein to refer to per- and/or polyfluoroalkyl substances. PFAS may include one or more perfluoroalkyl substances without any polyfluoroalkyl substances, one or more polyfluoroalkyl substances without any perfluoroalkyl substances, or one or more perfluoroalkyl substances and one or more polyfluoroalkyl substances. PFAS molecules are generally challenging to remove from liquid sources (e.g., water sources) especially those having relatively short alkyl chains. A primary, secondary, and/or tertiary foam fractionation process may facilitate the removal of the PFAS molecules from a liquid by concentrating the PFAS molecules in a foam prior to destruction. However, when concentrating the PFAS molecules using one or more foam fractionation steps, it may be challenging to liquify the foam for subsequent processing. This problem often becomes even more challenging at high PFAS concentrations. Accordingly, there is a need to remove concentrated PFAS molecules in a liquid for subsequent destruction. It has been realized in the context of this disclosure that the use of a membrane separator and a surfactant may facilitate the removal of the PFAS molecules. In some embodiments, the surfactant form micelles that associate with PFAS molecules and that can be removed and/or concentrated by the membrane separator. In some embodiments, removal of the PFAS molecules by the membrane separator may replace one or more foam fractionation processes, as the membrane separator may allow provide concentrated streams (e.g., liquid streams) of PFAS molecules for subsequent destruction processes.

The systems and the methods described in the present disclosure involve, in accordance with certain embodiments, removal of PFAS molecules. In general, some embodiments relate to systems comprising a membrane separator configured to receive a membrane separator input comprising PFAS molecules, a surfactant, and a liquid, and remove at least a portion of the PFAS molecules from the membrane separator input (and, thus, in accordance with certain embodiments, the feed). There are a variety of ways this can be done, examples of which can be found in the present disclosure. In general, some embodiments relate to methods comprising contacting a solution comprising PFAS molecules associated with a micelle comprising a surfactant with a semi-permeable membrane, such that at least a portion of the PFAS is removed from the solution. This disclosure describes a number of ways this can be achieved.

In some embodiments, the PFAS molecules are removed from the membrane separator retentate input or the foam fractionation separator input, as described in greater detail elsewhere in the present disclosure. To facilitate the removal of the PFAS molecules, the surfactant may be provided. In some embodiments, the surfactant is provided such that at least some of the PFAS molecules are associated with micelles comprising the surfactant. Any of a variety of surfactants may be suitable for this purpose. The micelles, in some embodiments, advantageously facilitate the removal of the PFAS molecules when the micelles are inputted into fluidic devices, such as the membrane separator and/or the foam fractionation separator. The micelles may allow for the membrane separator and/or the foam fractionation separator to concentrate the PFAS molecules in one or more outputs such that the concentration of the PFAS molecules in the one or more outputs is higher than the concentration of the PFAS molecules in the feed and/or the foam fractionation separator input. For the PFAS molecules to associate with the surfactant to form a micelle, in accordance with certain embodiments, a surprisingly low concentration of the surfactant may be necessary. In some embodiments, the foam fractionation separator may receive some or all of the membrane separator permeate output from the membrane separator to further remove any remaining PFAS molecules. In some embodiments, the membrane separator may receive some or all of the foam fractionated recovery output, exiting the foam fractionation separator, such that the PFAS molecules may be further concentrated.

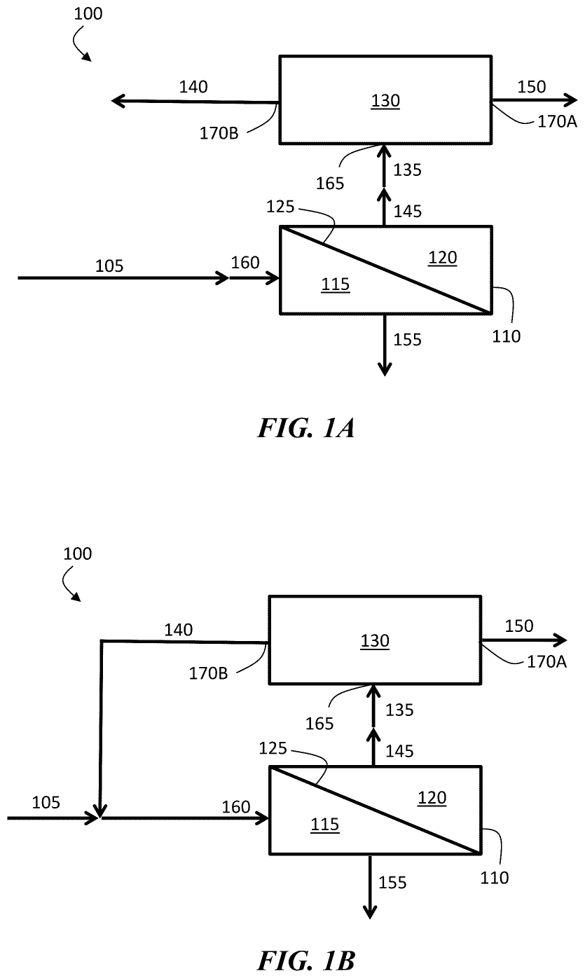

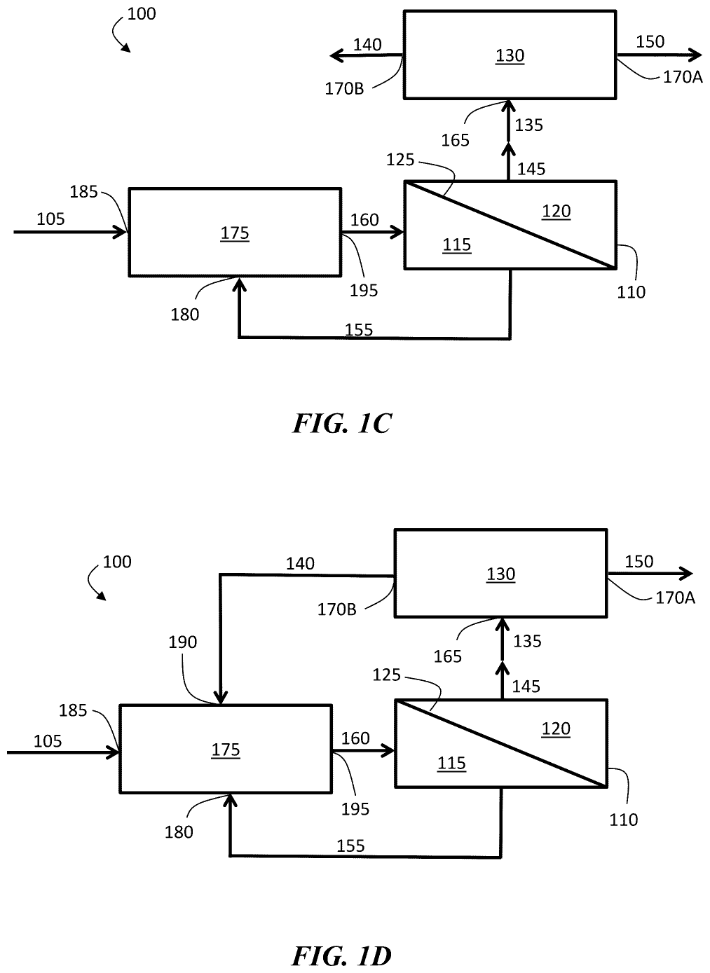

The PFAS molecules may be removed using any of a variety of suitable systems. One example of such a system is shown in FIG. 1A. In some embodiments, the system includes a membrane separator comprising at least one semi-permeable membrane defining a permeate side of the membrane separator and a retentate side of the membrane separator. For example, as shown in FIG. 1A, system 100 includes membrane separator 110 comprising semi-permeable membrane 125 defining permeate side 120 of membrane separator 110 and retentate side 115 of membrane separator 110. In certain embodiments, the retentate side of the membrane separator is configured to receive the membrane separator retentate input comprising PFAS molecules, a liquid, and a surfactant. For example, in FIG. 1A, retentate side 115 of membrane separator 110 is configured to receive membrane separator retentate input 160 comprising PFAS molecules, a liquid, and a surfactant. The membrane separator retentate input can be received by the membrane separator in any of a variety of ways. For example, as shown in FIG. 1A, the PFAS molecules, the liquid, and the surfactant are shown entering the membrane separator in a single stream. In other embodiments, the PFAS molecules, liquid, and surfactant can enter the membrane separator in two or more separate streams. Specific examples of configurations for feeding materials to membrane separators and other components are described in more detail below.

In some embodiments, the membrane separator retentate input entering the retentate side of the membrane separator comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the feed. For example, as shown in FIG. 1A, membrane separator retentate input 160 entering retentate side 115 of membrane separator 110 comprises all of feed 105. In some embodiments, in addition to comprising at least some of the feed, the membrane separator retentate input may also comprise any of a variety of other components, such as some or all of one or more outputs of one or more other components of the system (such as the foam fractionated recovery output described elsewhere in this disclosure).

In some embodiments, the system includes a foam fractionation separator comprising an inlet fluidically connected to the permeate side of the membrane separator and configured to receive a foam fractionation input. For example, as shown in FIG. 1A, system 100 includes foam fractionation separator 130 comprising inlet 165 fluidically connected to permeate side 120 of membrane separator 110 and configured to receive foam fractionation separator input 135. In some embodiments, the membrane separator retentate input can have a concentration of PFAS molecules that is greater (e.g., by a factor of at least 1.10, at least 1.25, at least 1.40, at least 1.50, at least 2, at least 3, at least 4, at least 5, at least 10, at least 50, at least 100, and/or up to 300, up to 500, up to 1000, or greater) than the concentration of PFAS molecules in the foam fractionation separator input. For example, as shown in FIG. 1A, membrane separator retentate input 160 has a concentration of PFAS molecules that is greater than the concentration of PFAS molecules in foam fractionation separator input 135. Greater detail regarding the relative concentration of the inputs and outputs of the system, in some embodiments, are described in more detail elsewhere in the present disclosure.

As used herein, when a second quantity is greater than a first quantity by a factor of X, then the magnitude of the second quantity is X times the first quantity. For example, if the first quantity is 5 and the second quantity is 100, then the second quantity is greater than the first quantity by a factor of 20 (because 5 times 20 is 100). Similarly, as used herein, when a first quantity is less than a second quantity by a factor of X, then, again, the magnitude of the second quantity is X times the first quantity. In the example above, the first quantity would be said to be less than the second quantity by a factor of 20 (again, because 5 times 20 is 100).

In some embodiments, the system includes a foam fractionation separator comprising one or more outlets configured to output a foam fractionated product output having a lower concentration of the PFAS molecules than the foam fractionation separator input. For example, as shown in FIG. 1A, system 100 includes foam fractionation separator 130 comprising outlet 170A configured to output foam fractionated product output 150 having a lower concentration of the PFAS molecules than foam fractionation separator input 135. Specific examples of configurations for outputting the foam fractionated product output are described in more detail below. In some embodiments, the concentration of the PFAS molecules in the foam fractionation separator input is greater (e.g., by a factor of at least 1.10, at least 1.25, at least 1.40, at least 1.50, at least 2, at least 3, at least 4, at least 5, at least 10, at least 50, at least 100, and/or up to 500, up to 1000, or greater) than the concentration of the PFAS molecules in the foam fractionated product output.

In some embodiments, the system includes a foam fractionation separator comprising one or more outlets configured to output a foam fractionated recovery output, the foam fractionated recovery output comprising at least some of the PFAS molecules and at least some of the surfactant. For example, as shown in FIG. 1A, system 100 includes foam fractionation separator 130 comprising outlet 170B configured to output foam fractionated recovery output 140, foam fractionated recovery output 140 comprising at least some of the PFAS molecules and at least some of the surfactant. In some embodiments, the concentration of the PFAS molecules in the foam fractionated recovery output is greater (e.g., by a factor of at least 1.25, at least 1.40, at least 1.50, at least 2, at least 3, at least 4, at least 5, at least 10, at least 50, at least 100, at least 1,000, at least 10,000, at least 100,000, and/or up to 500,000, up to 1,000,000, or greater) than the concentration of the PFAS molecules in the foam fractionation separator input. Specific examples of configurations for outputting the foam fractionated recovery output are described in more detail elsewhere in the present disclosure.

In some embodiments, the foam fractionation separator input entering the foam fractionation separator comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the membrane separator permeate output exiting the membrane separator. For example, as shown in FIG. 1A, foam fractionation separator input 135 entering foam fractionation separator 130 comprises all of membrane separator permeate output 145 exiting membrane separator 110.

In some embodiments, the foam fractionated recovery output can be recycled and/or processed by the membrane separator. One example of such an arrangement is illustrated in FIG. 1B. FIG. 1B is substantially the same as FIG. 1A, except that foam fractionation recovery output 140 is recycled and processed by membrane separator 110. In some embodiments, the membrane separator retentate input entering the membrane separator comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the foam fractionation recovery output exiting the foam fractionation separator. For example, in FIG. 1B, membrane separator retentate input 160 entering membrane separator 110 comprises all of foam fractionation recovery output 140 exiting foam fractionation separator 130.

In some embodiments, systems described herein include a vessel. One example of such a system is shown in FIG. 1C. FIG. 1C is similar to FIG. 1A, but further includes vessel 175 in fluidic communication with membrane separator 110. In some embodiments, the vessel is configured to receive at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the membrane separator retentate output via one or more inlets. For example, as shown in FIG. 1C, vessel 175 is configured to receive all of membrane separator retentate output 155, exiting from retentate side 115 of membrane separator 110, via inlet 180. In some embodiments, the vessel is configured to receive at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the feed via one or more inlets. For example, turning again to FIG. 1C, vessel 175 is configured to receive all of feed 105 via inlet 185. In some embodiments, the vessel is configured to output at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the membrane separator retentate input, via one or more outlets, to the membrane separator. For example, as shown in FIG. 1C, vessel 175 is configured to output all of membrane separator retentate input 160 via outlet 195 to membrane separator 110. The vessel, in accordance with certain embodiments, may serve to provide a stable source of the liquid, the PFAS molecules, and/or the surfactant to other components of the system. While one vessel is illustrated in FIG. 1C, in other embodiments, multiple vessels could be used (e.g., one for the liquid and the PFAS molecules, and another for the surfactant).

In some embodiments, the vessel is configured to receive at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the foam fractionated recovery output exiting the foam fractionation separator. One example of such a system is shown in FIG. 1D. FIG. 1D is substantially the same as FIG. 1C, except that vessel 175 is configured to receive all of foam fractionation recovery output 140 exiting foam fractionation separator 130 via inlet 190. The vessel, by receiving at least a portion of the foam fractionated recovery output, may provide at least a portion the foam fractionated recovery output to the membrane separator for recycling and/or further processing (e.g., to further concentrate the PFAS molecules).

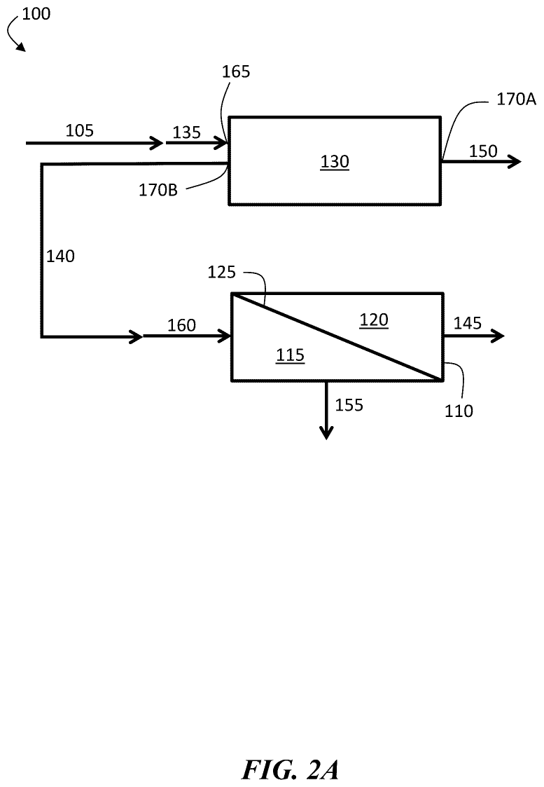

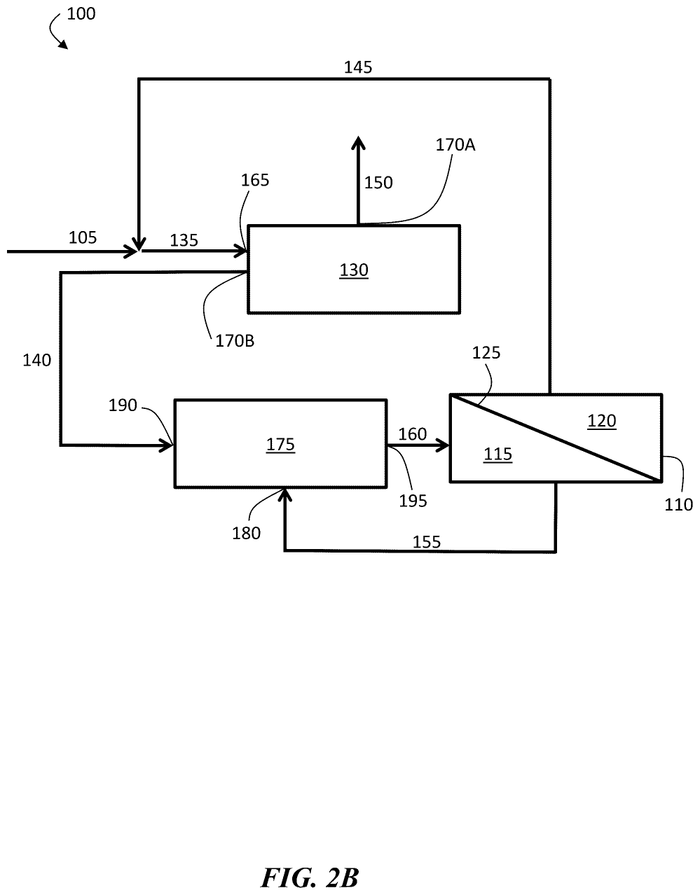

As mentioned above, PFAS molecules may be removed in any of a variety of suitable systems. Another example of such a system is shown in FIG. 2A. In some embodiments, the system includes a foam fractionation separator. For example, as shown in FIG. 2A, system 100 comprises foam fractionation separator 130. In some embodiments, the foam fractionation separator comprises one or more inlets configured to receive a foam fractionation separator input. For example, as shown in FIG. 2A, foam fractionation separator 130 comprises inlet 165 configured to receive foam fractionation separator input 135. In some embodiments, the foam fractionation separator input comprises PFAS molecules and liquid. Greater detail regarding the foam fractionation separator input can be found elsewhere in this disclosure.

In some embodiments, the foam fractionation separator is configured to receive a foam fractionation separator input comprising at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the feed. For example, as shown in FIG. 2A, foam fractionation separator 130 is configured to receive foam fractionation separator input 135 comprising all of feed 105.

In some embodiments, the foam fractionation separator comprises one or more outlets configured to output foam fractionated recovery output. For example, as shown in FIG. 2A, foam fractionation separator 130 comprises outlet 170B configured to output foam fractionated recovery output 140. In some embodiments, the concentration of the PFAS molecules in the foam fractionated recovery output is greater (e.g., by a factor of at least 2.5, at least 3, at least 4, at least 5, at least 10, at least 50, at least 100, at least 1,000, at least 100,000, at least 1,000,000, and/or up to 500,000,000, up to 1,000,000,000, or greater) than the concentration of the PFAS molecules in the foam fractionated product output. Greater detail regarding the foam fractionation separator is described elsewhere in the present disclosure.

The foam fractionation input, in some embodiments, can be processed by the foam fractionation separator such that the foam fractionation recovery output has a concentration of the PFAS molecules greater (e.g., by a factor of at least 1.10, at least 1.25, at least 1.40, at least 1.50, at least 2, at least 3, at least 4, at least 5, at least 10, at least 50, at least 100, at least 1,000, at least 10,000, at least 100,000, and/or up to 500,000, up to 1,000,000, or greater) than the concentration of the PFAS molecules in the foam fractionation separator input. For example, foam fractionation recovery output 140 exiting membrane separator 110 has a concentration of PFAS molecules greater than the concentration of PFAS molecules in foam fractionation separator input 135. In some embodiments, the foam fractionation separator comprises one or more outlets configured to output a foam fractionated product output having a lower concentration of the PFAS molecules than the foam fractionation separator input. For example, as shown in FIG. 2A, foam fractionation separator 130 comprises outlet 170A configured to output foam fractionated product output 150 having a lower concentration of the PFAS molecules than foam fractionation separator input 135. In some embodiments, the concentration of the PFAS molecules in the foam fractionated product output is less (e.g., by a factor of at least 1.25, at least 1.40, at least 1.50, at least 2, at least 3, at least 4, at least 5, at least 10, at least 100, and/or up to 500, up to 1000, or greater) than the concentration of the PFAS molecules in the foam fractionated separator input.

In some embodiments, the system includes a membrane separator comprising at least one semi-permeable membrane defining a permeate side of the membrane separator and a retentate side of the membrane separator. For example, as shown in FIG. 2A, system 100 includes a membrane separator 110 comprising at least one semi-permeable membrane 125 defining permeate side 120 of membrane separator 110 and retentate side 115 of membrane separator 110. In some embodiments, the retentate side of the membrane separator is configured to receive at least a portion of a foam fractionated recovery output comprising PFAS molecules, a liquid, and a surfactant. For example, in FIG. 2A, retentate side 115 of membrane separator 110 is configured to receive all of foam fractionated recovery output 140 comprising PFAS molecules, a liquid, and a surfactant.

In some embodiments, the foam fractionated recovery output can be recycled and further processed by the membrane separator. In some embodiments, the membrane separator retentate input comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the foam fractionated recovery output exiting the foam fractionation separator. For example, in FIG. 2A, membrane separator retentate input 160 comprises all of foam fractionated recovery output 140 exiting foam fractionation separator 130. In some embodiments, the membrane separator retentate output has a concentration of the PFAS molecules that is greater than (e.g., by a factor of at least 1.10, at least 1.25, at least 1.40, at least 1.50, at least 2, at least 3, at least 4, at least 5, at least 10, at least 100, and/or up to 200, up to 300, up to 500, or greater) the concentration of the PFAS molecules in the membrane separator retentate input. For example, as shown in FIG. 2A, membrane separator retentate output 155 can have a concentration of PFAS molecules that is greater than the concentration of PFAS molecules in membrane separator retentate input 160 entering retentate side 115 of membrane separator 110.

In some embodiments, the membrane separator is configured to output membrane separator permeate output. For example, as shown in FIG. 2A, membrane separator 110 is configured to output membrane separator permeate output 145 from permeate side 120 of membrane separator 110. In some embodiments, the membrane separator retentate output has a concentration of the PFAS molecules that is greater than the concentration of the PFAS molecules in the membrane separator permeate output. For example, membrane separator retentate output 155 exiting retentate side 115 of membrane separator 110 has a higher concentration of PFAS molecules than the concentration of PFAS molecules in membrane separator permeate output 145 exiting permeate side 120 of membrane separator 110.

In some embodiments, the system includes a vessel configured to receive the foam fractionated recovery output and/or the membrane separator retentate output. One example of such a system is shown in FIG. 2B. As shown FIG. 2B, system 100 includes vessel 175. Vessel 175 is configured to receive foam fractionated recovery output 140 via inlet 190 and/or membrane separator retentate output 155, via inlet 180, exiting retentate side 115 of membrane separator 110. In some embodiments, the vessel serves to provide a stable source of the liquid, the PFAS molecules, and/or the surfactant to the membrane separator.

In some embodiments, the foam fractionated separator input comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the membrane separator permeate output. For example, as shown in FIG. 2B, foam fractionation separator input 135 comprises all of membrane separator permeate output 145 exiting permeate side 120 of membrane separator 110. In some embodiments, the foam fractionation separator input comprises a relatively low concentration of the PFAS molecules.

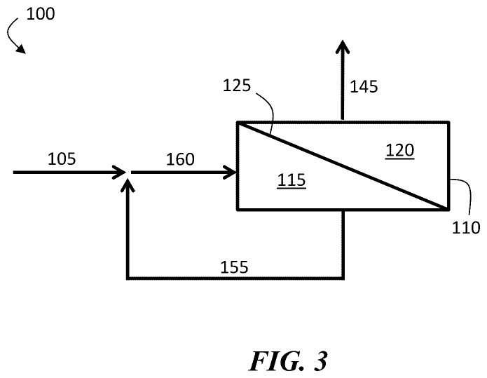

While FIGS. 1A-1D and 2A-2B include both a membrane separator and a foam fractionation separator, the use of a foam fractionation separator is optional, and in some embodiments, only the membrane separator may be used. One example of such an embodiment is shown in FIG. 3. In FIG. 3, system 100 comprises membrane separator 110, which comprises semi-permeable membrane 125 which establishes retentate side 115 and permeate side 120. System 100 further comprises membrane separator permeate output 145 exiting permeate side 120 of membrane separator 110 and membrane separator retentate input 160 entering retentate side 115 of membrane separator 110. Membrane separator retentate input 160 comprises feed 105 and may also optionally comprise membrane separator retentate output 155.

PFAS molecules may be removed from a feed using any of a variety of suitable methods. An example of such a method will be described using the system shown in FIG. 3 as a reference, as well as the systems shown in FIGS. 1A-1D and FIGS. 2A-2B as references. In some embodiments, the method includes removing an amount of PFAS molecules from a feed comprising liquid and the PFAS molecules. For example, as shown in FIG. 3, the method can include removing an amount of PFAS molecules from feed 105 comprising liquid and the PFAS molecules. Similarly, removing PFAS molecules from feed 105 can be achieved using the systems shown in FIGS. 1A-1D and FIGS. 2A-2B.

In some embodiments, the removing comprises transporting a membrane separator retentate input to a retentate side of a membrane separator, the membrane separator retentate input comprising at least a portion of the feed and a surfactant present such that at least some of the PFAS molecules are associated with a micelle comprising the surfactant. For example, as shown in FIG. 3, the removing can comprise transporting membrane separator retentate input 160 to retentate side 115 of membrane separator 110, membrane separator retentate input 160 comprising at least a portion of feed 105 and a surfactant present such that at least some of the PFAS molecules are associated with a micelle comprising the surfactant. Similar operation can be achieved using the systems shown in FIGS. 1A-1D and FIGS. 2A-2B. In some embodiments, the membrane separator retentate input is transported such that a membrane separator retentate output exits the retentate side of the membrane separator. For example, as shown in FIG. 3, membrane separator retentate input 160 is transported such that membrane separator retentate output 155 exits the retentate side of the membrane separator. Similar operation can be achieved using the systems shown in FIGS. 1A-1D and FIGS. 2A-2B.

In some embodiments, the membrane separator retentate input is transported such that at least a portion of liquid from the membrane separator retentate input is transported from the retentate side of the membrane separator, through a semi-permeable membrane of the membrane separator, to a permeate side of the membrane separator to form some or all of a membrane separator permeate output having a concentration of the PFAS molecules that is less than that of the membrane separator retentate input. For example, as shown in FIG. 3, membrane separator retentate input 160 is transported such that at least a portion of liquid from membrane separator retentate input 160 is transported from retentate side 115 of membrane separator 110, through semi-permeable membrane 125 of membrane separator 110, to permeate side 120 of membrane separator 110 to form some or all of membrane separator permeate output 145 having a concentration of the PFAS molecules that is less than that of membrane separator retentate input 160. Similar operation can be achieved using the systems shown in FIGS. 1A-1D and FIGS. 2A-2B.

In some embodiments, the concentration of the PFAS molecules in the membrane separator retentate output is greater (e.g., by a factor of at least 1.03, at least 1.035, at least 1.05, at least 1.10, at least 1.25, at least 1.40, at least 1.50, at least 2, at least 3, at least 4, at least 5, at least 10, and/or up to 20, up to 50, or greater) than the concentration of the PFAS molecules in the membrane separator permeate output. In some embodiments, the concentration of the PFAS molecules in the membrane separator retentate output is greater (e.g., by a factor of at least 1.03, at least 1.035, at least 1.05, at least 1.10, at least 1.25, at least 1.40, at least 1.50, at least 2, at least 3, at least 4, at least 5, at least 10, and/or up to 20, up to 50, or greater) than the concentration of the PFAS molecules in the membrane separator retentate input.

In some embodiments, the membrane separator retentate input comprises at least a portion of the membrane separator retentate output, which comprises at least some of the PFAS molecules transported to the retentate side of the membrane separator. For example, as shown in FIG. 3, membrane separator retentate input 160 comprises at least a portion of membrane separator retentate output 155, which comprises at least some of the PFAS molecules transported to retentate side 115 of membrane separator 110. Similar operation is shown, for example, in FIGS. 1C-1D and 2B. In some embodiments, the membrane separator retentate input comprise at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the membrane separator retentate output. Specific examples of configurations for the membrane separator retentate input and other components are described in more detail below. Accordingly, since the membrane separator retentate input may comprise at least a portion of the membrane separator retentate output, the membrane separator retentate output may be advantageously recycled through the membrane separator thereby enhancing separation of the PFAS molecules from remaining liquid in the membrane separator retentate output. As the membrane separator retentate output is recycled into the membrane separator, the concentration of the PFAS molecules in the membrane separator retentate output may increase as the liquid is removed (e.g., by permeating through the semi-permeable membrane). In some embodiments, the recycling of the membrane separator retentate output in this manner may advantageously reduce the amount of the liquid that may need to be discarded during the removal (and/or subsequent destruction) of the PFAS molecules.

In some embodiments, the concentration of PFAS molecules in the membrane separator permeate output is lower (e.g., at least 90% lower, at least 95% lower, or at least 99% lower) than the concentration of PFAS molecules in the feed. For example, referring to FIGS. 1A-1D and FIG. 3 in some embodiments, the concentration of the PFAS molecules in membrane separator permeate output 145 is at least 90% lower than the concentration of the PFAS molecule in feed 105. As a further example, referring to FIGS. 2A-2B, in some embodiments, the concentration of the PFAS molecules in the membrane separator permeate output 145 is at least 90% lower than the concentration of the PFAS molecules in feed 105.

As used herein, when a first quantity is a specified percentage, X %, lower than a second quantity, it means that the first quantity is 100% minus X % of the second quantity. To illustrate, if the first quantity is 90% lower than the second quantity, then the first quantity is 10% of the second quantity (because 100% minus 90% is 10%). As a specific example, if the second quantity is 50, and the first quantity is 90% lower than the second quantity, then the first quantity would be 5 (because 10% of 50 is 5).

Similarly, as used herein, when a first quantity is a specified percentage, Y %, higher than a second quantity, it means that the first quantity is 100% plus Y % of the second quantity. To illustrate, if the first quantity is 90% greater than the second quantity, then the first quantity is 190% of the second quantity. As a specific example, if the second quantity is 50, and the first quantity is 90% greater than the second quantity, then the first quantity would be 95 (because 100% plus 90% is 190%, and 190% of 50 is 95).

In some embodiments, the concentration of the surfactant in the membrane separator retentate input is greater than or equal to 100 mg/L and less than or equal to 1000 mg/L. In some embodiments, the concentration of the surfactant in the membrane separator retentate input is greater than or equal to 200 mg/L and less than or equal to 360 mg/L. In some embodiments, membrane separator retentate input has a relatively low concentration of the surfactant. Greater detail regarding the concentration of the surfactant in the feed and/or inputs/outputs of the system are described elsewhere in the present disclosure.

In association with various embodiments, inputs (e.g., the foam fractionation separator input, the membrane separator retentate input, etc.) and outputs (e.g., the foam fractionated recovery output, the membrane separator retentate output, etc.) are described. In each case the input and/or output may be in the form of a single stream or multiple streams. In some embodiments, it can be advantageous to use a single stream, as opposed to multiple streams. Thus, in some embodiments, the foam fractionation separator input is in the form of a single stream. In certain embodiments, the foam fractionated recovery output is in the form of a single stream. In certain embodiments, the foam fractionated product output is in the form of a single stream. In certain embodiments, the membrane separator retentate input is in the form of a single stream. In some embodiments, the membrane separator retentate output is in the form of a single stream. In some embodiments, the membrane separator permeate output is in the form of a single stream.

The systems and the methods described in the present disclosure involve, in accordance with certain embodiments, the processing of a feed. The feed may have any of variety of forms. For example, the feed may be in a form suitable for input into a fluidic device including but not limited a membrane separator, a foam fractionation separator, a vessel, and/or components used for fluidic control. For example, in FIG. 1A, system 100 is configured to receive feed 105, at least a portion of which can be input, via membrane separator retentate input 160, into membrane separator 110 comprising semi-permeable membrane 125 defining retentate side 115 and permeate side 120. Membrane separator retentate input 160 comprising at least a portion of feed 105 may enter retentate side 115 of membrane separator 110 such some or all of membrane separator retentate input 160 is transported through semi-permeable membrane 125 while PFAS molecules are retained by semi-permeable membrane 125. This can lead to an increase in concentration of PFAS in an output from retentate side 115 relative to the input into the retentate side 115. As another example, in FIG. 1C, system 100 is configured to receive feed 105, at least a portion of which can be input into vessel 175. In some embodiments, the membrane separator retentate input comprises at least a portion of the feed. For example, in FIG. 1A, membrane separator retentate input 160, entering retentate side 115 of membrane separator 110, comprises at least a portion of feed 105. In some embodiments, the vessel, the membrane separator, and/or the foam fractionation separator may receive the feed via an inlet.

In some embodiments, the feed is a single stream (e.g., a stream comprising a liquid) comprising all components to be inputted into a fluidic device (e.g., the membrane separator via the membrane separator retentate input). In some embodiments, the feed has multiple streams. In either case, in accordance with certain embodiments, the feed is an input to the system from one or more external sources as described below. Accordingly, in some embodiments, the feed introduces the PFAS molecules to the system for subsequent removal. In some embodiments, any of the inputs and/or outputs comprise a portion of the feed or contents derived from the feed (e.g., the PFAS molecules and/or the liquid). In some embodiments, the feed feeds the system with PFAS molecules and the liquid. That is, the feed may serve as a source for the system such that the system may receive the liquid and the PFAS molecules for subsequent removal of the PFAS molecules.

In some embodiments, the feed comprises PFAS molecules. The feed can be derived from any of a variety of different sources. For example, in some embodiments, the feed is partially or completely derived from an industrial waste stream (e.g., discarded material from industrial and/or manufacturing processes) comprising the PFAS molecules and/or a liquid source exposed to an industrial waste stream comprising the PFAS molecules. In some embodiments, the feed comprises the liquid and/or the PFAS molecules. In some embodiments, the feed further comprises any of a variety of contaminants, waste products, and/or compounds that may be undesirable in any of a variety of applications. In some embodiments, the feed is a stream. In some embodiments, the feed is a single stream comprising the liquid and the PFAS molecules. That is, the feed may be in the form of a single flowing stream comprising the liquid and the PFAS molecules. In some embodiments, the feed comprises multiple streams each comprising at least a portion of either the liquid and/or the PFAS molecules. In some embodiments, the multiple streams are combined prior to input into a fluidic device (e.g., the membrane separator or foam fractionation separator), within the fluidic device, or within the vessel. Prior to their combination, each of the multiple streams may have different compositions. As an example, some of the multiple streams may comprise a relatively high amount of the PFAS molecules while others may comprise a relatively high amount of the liquid. In other embodiments, the multiple streams are input in the fluidic device (e.g., the membrane separator or foam fractionation separator) via separate inlets.

In some embodiments, the PFAS molecules comprise at least one perfluoroalkyl moiety (—CₙF₂ₙ₊₁). In some embodiments, the PFAS molecules comprises a perfluorinated methyl group (—CF₃). In some embodiments, the PFAS molecules comprise and/or a perfluorinated methylene group (—CF₂—). Examples of perfluoroalkyl moieties include but are not limited to perfluorooctane (R—C₈F₁₇), perfluorohexane (R—C₆F₁₃), and/or perfluorobutane (R—C₄F₉), where “R” can be any of a variety of head groups including but not limited to a carboxylic acid, sulfonic acid, and/or phosphonic acid. In some embodiments, the PFAS molecules comprise perfluorooctanoic acid, perfluorooctanesulfonic acid, perfluorohexanesulphonic acid, perfluorobutanesulfonic acid (PFBS), perfluorobutanoic acid, perfluoroalkyl acids (PFAA), perfluoroalkyl carboxylic acids, perfluoroalkyl carboxylates, perfluoroalkane sulfonic acids, perfluoroalkance sulfonates (PFSA), perfluoroalkyl ether acids, perfluoroalkance sulfonyl fluorides (PASF), perfluoroalkane sulfonamides (FASA), perfluoroalkanoyl fluorides (PFA), perfluoroalkyl iodides (PFAI), perfluoroalkyl aldehydes, fluorotelomer substances, polyfluoroalkane sufonamido substances, polyfluoroalkyl ether acids, chloropolyfluoroalkyl ether acids, and/or chloropolyfluoroalkyl acids. In some embodiments, the PFAS molecules comprises one or more molecules disclosed in the “Per- and Polyfluoroalkyl Substances (PFAS) Report” by the Joint Subcommittee on Environment, Innovation, and Public Health Per- and Polyfluoroalkyl Substances Strategy Team of the National Science and Technology Council published in March 2023, which is incorporated herein by reference in its entirety for all purposes.

In some embodiments, at least some (e.g., at least 10 mole percent (mol %), at least 25 mol %, at least 50 mol %, at least 75 mol %, at least 90 mol %, at least 95 mol %, at least 99 mol %, or all) of the PFAS molecules are anionic. For example, some of the PFAS molecules may comprise a carboxylate group, a phosphate group, and/or a sulfonate group. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules are anionic when present in the feed. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise a negatively charged terminal group. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise a polar portion (e.g., a carboxylate group, a phosphate group, a sulfonate group). In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise a nonpolar portion (e.g., an alkyl chain partially or fully saturated with fluorine atoms). The PFAS molecules may have any of a variety of molecular weights. In some embodiments, the PFAS molecules have a molecular weight of at least 100 g/mol, at least 150 g/mol, at least 200 g/mol, at least 250 g/mol, at least 300 g/mol, at least 400 g/mol, at least 500 g/mol, at least 600 g/mol, and/or up to 800 g/mol, up to 1000 g/mol, or more. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise an alkyl chain comprising at least 2 carbon atoms, at least 4 carbon atoms, at least 6 carbon atoms, at least 8 carbon atoms, at least 10 carbon atoms, at least 12 carbon atoms, at least 14 carbon atoms, at least 16 carbon atoms, at least 18 carbon atoms, at least 20 carbon atoms, and/or up to 25 carbon atoms, up to 30 carbon atoms, or more.

In some embodiments, the feed comprises a relatively high concentration of dissolved ions. The dissolved ions may not be PFAS molecules and may not be surfactants. Examples of such dissolved ions include but are not limited to sulfate, calcium, sodium, and/or chloride. In some embodiments, the dissolved ions have an atomic or molecular weight less than or equal to 100 g/mol or less. The dissolved ions may comprise cations and anions of a dissolved salt. For instance, the feed may comprise calcium sulfate (CaSO₄) that dissociates in water to form calcium ions and sulfate ions. Other dissolved ions are also possible including oxyanions, halide ions, and/or ions comprising Group I and/or Group II elements.

In some embodiments, the membrane separator is capable of rejecting a relatively high percentage of PFAS molecules (e.g., as part of PFAS-associated micelles) while allowing a relatively large percentage of the dissolved ions (e.g., sulfate) to be transported from the retentate side of the membrane separator, through the semi-permeable membrane, to the permeate side of the membrane separator. The dissolved ions may then exit the membrane separator via the membrane separator permeate output. For example, as shown in FIG. 1A, membrane separator retentate input 160 comprising dissolved ions and PFAS molecules enters retentate side 115 of membrane separator 110. While some or all of the PFAS molecules and/or PFAS-associated micelles may be rejected and exit membrane separator 110 via membrane separator retentate output 155, some or all of the dissolved ions may be transported from retentate side 115 of membrane separator 110, through semi-permeable membrane 125, to permeate side 120 of membrane separator 110. The dissolved ions may exit membrane separator 110 via membrane separator permeate output 145.

In some embodiments, the semi-permeable membrane has a relatively low rejection percentage for the dissolved ions (e.g., non-PFAS and non-surfactant ions) as compared to the rejection of other molecules such as PFAS molecules. The rejection percentage, R, of a semi-permeable membrane for a solute during a liquid separation process can be calculated from C_{R} (the concentration of the solute in the membrane separator retentate input on the retentate side of the membrane) and C_{P} (the concentration of the solute in membrane separator permeate output on the permeate side of the membrane) and expressed as a percentage using Equation [1] below:

$$R = [ 1 - ( {C}_{P} / {C}_{R} ) ] * 100 \qquad [ 1 ]$$

In some embodiments, the semi-permeable membrane of the membrane separator is configured to reject (e.g., under the conditions of the process of this disclosure) dissolved ions at a rejection percentage of less than or equal to 80%, less than or equal to 60%, less than or equal to 50%, less than or equal to 40%, and/or at least 0.5%, at least 0.1%, at least 0.01%, or less. Combinations of these ranges are possible (e.g., less than or equal to 80% and at least 0.01%, or less than or equal to 40% and at least 0.01%). In some embodiments, the semi-permeable membrane is configured to reject (e.g., under the conditions of the process of this disclosure) the PFAS molecules and/or PFAS-associated micelles at a rejection percentage of at least 80%, at least 85%, at least 90%, at least 95%, and/or up to 99%, up to 99.5%, up to 99.9%, or more (e.g., 100%). Combinations of these ranges are possible. In some embodiments, a ratio of the rejection percentage of the PFAS molecules and/or PFAS-associated micelles to the rejection percentage of the dissolved ions (e.g., sulfate) at the membrane separator is greater than 1, at least 1.05, at least 1.1, at least 1.2, at least 1.25, at least 1.5, at least 2, at least 3, at least 4, and/or up to 10, up to 100, up to 500, or up to 1000, or more. Combinations of these ranges are possible (e.g., greater than 1 and up to 1000). Other ranges are also possible.

In some embodiments, the semi-permeable membrane is configured to reject (e.g., under the conditions of the process of this disclosure) a relatively large percentage of the PFAS molecules and/or PFAS-associated micelles while allowing transport of a relatively high percentage of the dissolved ions, such as sulfate, through the semi-permeable membrane. In some embodiments, it is undesirable to use semi-permeable membranes that reject a relatively high percentage of the certain ions such as sulfate, as those ions may scale on the semi-permeable membrane reducing the performance thereof. Moreover, such ion scaling may impact performance on downstream processes such as oxidation processes (e.g., for PFAS destruction). In some embodiments, the membrane separator permeate output has a concentration of the dissolved ions that is less than (e.g., by a factor of at least 1.005, at least 1.01, at least 1.05, at least 1.1, at least 1.25, at least 1.40, at least 1.50, at least 2, at least 3, at least 4, at least 5, at least 10, at least 100, and/or up to 500, up to 1000, or greater) the concentration of the dissolved ions in the membrane separator retentate input. In some embodiments, the membrane separator permeate output has a concentration of the dissolved ions that is within 5%, within 2%, within 1%, within 0.5%, within 0.2%, within 0.1%, or less of the concentration of the dissolved ions in the membrane separator retentate input. In some embodiments, the membrane separator permeate output has a concentration of the dissolved ions that is the same as concentration of the dissolved ions in the membrane separator retentate input. In some embodiments, the membrane separator permeate output has a concentration of dissolved sulfate that is less than (e.g., by a factor of at least 1.005, at least 1.01, at least 1.05, at least 1.1, at least 1.25, at least 1.40, at least 1.50, at least 2, at least 3, at least 4, at least 5, at least 10, at least 100, and/or up to 500, up to 1000, or greater) the concentration of dissolved sulfate in the membrane separator retentate input. In some embodiments, the membrane separator permeate output has a concentration of dissolved sulfate that is within 5%, within 2%, within 1%, within 0.5%, within 0.2%, within 0.1%, or less of the concentration of dissolved sulfate in the membrane separator retentate input. In some embodiments, the membrane separator permeate output has a concentration of dissolved sulfate that is the same as concentration of dissolved sulfate in the membrane separator retentate input.

In some embodiments, the membrane separator retentate input has a concentration of the dissolved ions greater than or equal to 15 mg/L, greater than or equal to 20 mg/L, greater than or equal to 25 mg/L, greater than or equal to 50 mg/L, greater than or equal to 100 mg/L, greater than or equal to 150 mg/L, greater than or equal to 200 mg/L, greater than or equal to 300 mg/L, greater than or equal to 400 mg/L, greater than or equal to 500 mg/L, greater than or equal to 650 mg/L, greater than or equal to 675 mg/L, and/or up to 700 mg/L, or greater. In some embodiments, the membrane separator permeate output has a concentration of the dissolved ions less than or equal to 700 mg/L, less than or equal to 650 mg/L, less than or equal to 600 mg/L, less than or equal to 500 mg/L, less than or equal to 400 mg/L, less than or equal to 250 mg/L, less than or equal to 100 mg/L, less than or equal to 50 mg/L, less than or equal to 20 mg/L, less than or equal to 10 mg/L, less than or equal to 5 mg/L, less than or equal to 1 mg/L, or less.

The pH of the membrane separator retentate input and/or the foam fractionation separator input may have any of a variety of values depending on, for example, the content and/or amounts of its constituents (e.g., PFAS molecules, surfactant). The pH may be one that promotes formation of micelles that associate at least some of the PFAS molecules. In some embodiments, the pH of the membrane separator retentate input and/or the foam fractionations separator input is sufficiently low to prevent dissociation of the micelle. In some embodiments, the pH of the membrane separator retentate input and/or the foam fractionations separator input is less than or equal to 9 to prevent dissociation of the micelle. In some embodiments, the pH of the membrane separator retentate input and/or the foam fractionations separator input is greater than or equal to 6.5, greater than or equal to 6.75, greater than or equal to 7, greater than or equal to 7.25, greater than or equal to 7.5, greater than or equal to 7.75, greater than or equal to 8, greater than or equal to 8.25, greater than or equal to 8.5, greater than or equal to 8.75, or greater than or equal to 9. In some embodiments, the pH of the membrane separator retentate input and/or the foam fractionations separator input is less than or equal to 9, less than or equal to 8.75, less than or equal to 8.5, less than or equal to 8, less than or equal to 7.75, less than or equal to 7.5, less than or equal to 7.25, less than or equal to 7, less than or equal to 6.75, or less than or equal to 6.5. Combinations of these ranges are possible (e.g., greater than or equal to 6.5 and less than or equal to 9). Other ranges are possible.

In some embodiments, the membrane separator retentate input and/or the foam fractionations separator input may have any of a variety of volume-averaged temperatures. The volume-averaged temperature of the membrane separator retentate input and/or the foam fractionations separator input may be, according to some embodiments, approximately ambient temperature. In accordance with some embodiments, the membrane separator retentate input and/or the foam fractionations separator input having a volume-averaged temperature of approximately ambient temperature (e.g., greater than or equal to 20 degrees Celsius and less than or equal to 25 degrees Celsius) may advantageously allow for relatively larger micelle sizes and relatively stable micelle formation. In some embodiments, the volume-averaged temperature of the membrane separator retentate input and/or the foam fractionations separator input is greater than or equal to 20 degrees Celsius and less than or equal to 25 degrees Celsius. In some embodiments, the volume-averaged temperature of the feed is greater than or equal to 15 degrees Celsius, greater than or equal to 17.5 degrees Celsius, greater than or equal to 20 degrees Celsius, greater than or equal to 22.5 degrees Celsius, greater than or equal to 25 degrees Celsius, greater than or equal to 27.5 degrees Celsius, or greater than or equal to 30 degrees Celsius. In some embodiments, the volume-averaged temperature of the membrane separator retentate input and/or the foam fractionations separator input is less than or equal to 30 degrees Celsius, less than or equal to 27.5 degrees Celsius, less than or equal to 25 degrees Celsius, less than or equal to 22.5 degrees Celsius, less than or equal to 20 degrees Celsius, less than or equal to 17.5 degrees Celsius, or less than or equal to 15 degrees Celsius. Combinations of these ranges are possible (e.g., greater than or equal to 15 degrees Celsius and less than or equal to 30 degrees Celsius). Other ranges are possible.

In some embodiments, the membrane separator retentate input and/or the foam fractionations separator input is pressurized. The membrane separator retentate input and/or the foam fractionations separator input may be pressurized by any of variety of suitable mechanisms including but not limited to a feed pump and/or gravity. In some embodiments, the membrane separator retentate input and/or the foam fractionations separator input is pressurized to a gauge pressure of greater than or equal to 1 bar, greater than or equal to 5 bar, greater than or equal to 10 bar, greater than or equal to 15 bar, or greater than or equal to 20 bar. In some embodiments, the membrane separator retentate input and/or the foam fractionations separator input is pressurized to a gauge pressure of less than or equal to 20 bar, less than or equal to 15 bar, less than or equal to 10 bar, less than or equal to 5 bar, or less than or equal to 1 bar. Combination of these ranges are possible (e.g., greater than or equal to 1 bar and less than or equal to 20 bar). Other ranges are possible.

In some embodiments, the membrane separator retentate input is pressurized such that a desired amount of flux across the semi-permeable membrane is achieved. In some embodiments, the membrane separator retentate input is pressurized such that the flux across the semi-permeable membrane is greater than or equal to 10 liter/m²/hr (LMH), greater than or equal to 15 LMH, greater than or equal to 20 LMH, greater than or equal to 25 LMH, greater than or equal to 30 LMH, greater than or equal to 35 LMH, or greater than or equal to 40 LMH. In some embodiments, the membrane separator retentate input is pressurized such that the flux across the semi-permeable membrane is less than or equal to 40 LMH, less than or equal to 35 LMH, less than or equal to 30 LMH, less than or equal to 25 LMH, less than or equal to 20 LMH, less than or equal to 15 LMH, or less than or equal to 10 LMH. Combinations of these ranges are possible (e.g., greater than or equal to 10 LMH and less than or equal to 40 LMH). Other ranges are possible.

In some embodiments, the feed comprises a liquid. The liquid, in certain instances, comprises industrial waste products. In some embodiments, the liquid comprises water. In accordance with certain embodiments, the relatively low reactivity of the PFAS molecules make it challenging to remove them from liquids (e.g., water) and are generally undesirable in many applications (e.g., in drinking water). Accordingly, the removal of the PFAS molecules from the feed may advantageously allow for the liquid and/or other components in the feed to be used for various applications and/or introduced into the environment.

The inputs described throughout the present disclosure may comprise a surfactant. In some embodiments, the surfactant is amphiphilic. In some embodiments, the surfactant may associate with the PFAS molecules to form micelles. In accordance with some embodiments, the surfactant allows for the formation of micelles with which the PFAS molecules associate. In accordance with some embodiments, the surfactant can assist with the removal of the PFAS molecules from the membrane separator retentate input, as the micelles may have limited permeability through the semi-permeable membrane.

In some embodiments, the surfactant can be dosed into the vessel, the separator(s), or any of the inputs and/or outputs of the system. In some embodiments, the surfactant is dosed in a continuous manner. That is, a continuous supply of the surfactant is, in some embodiments, introduced with limited interruption. In some embodiments, the surfactant is dosed intermittently. That is, a supply of surfactant is, in some embodiments, introduced in batches (e.g., intermittent doses of discrete amounts). In certain embodiments, the surfactant is introduced to any of the inputs and/or outputs of the system described herein including but not limited to the foam fractionation separator input, the foam fractionated recovery output, the membrane separator retentate output, the membrane separator permeate output, and/or the membrane separator retentate input.

In some embodiments, the surfactant comprises a cationic surfactant. That is, the surfactant comprises, in some embodiments, a portion having a net positive charge. In some embodiments, the cationic surfactant may interact with the PFAS molecules such that the portion having a net positive charge interacts with a portion of the PFAS molecules having a net negative charge to form a micelle. The electrostatic interaction between the portion of the PFAS having a net negative charge and the portion of the cationic surfactant having a net positive charge may allow for the formation of relatively stable and relatively large micelles which would aid removal using the semi-permeable membrane. Advantageously, the electrostatic interaction between the cationic surfactant and the PFAS molecules may allow for the removal of relatively short-chain PFAS molecules (e.g., perfluorobutanoic acid, perfluorobutanesulfonic acid). Accordingly, the electrostatic interaction between the cationic surfactant and the PFAS molecules may promote the separation of short-chain PFAS compounds.

The cationic surfactant described herein can comprise any of a variety of compounds. In some embodiments, the cationic surfactant comprises cetyltrimethylammonium bromide (CTAB), trimethyloctylammonium bromide, trimethyloctadecylammonium bromide, dimethyldidecylammonium bromide, dimethyldidodecylammonium bromide, dimethylditetradecylammonium bromide, dimethyldihexadecylammonium bromide, dimethyldioctadecylammonium bromide, cetyltrimethylammonium chloride, and/or cetylpyridinium chloride. In some embodiments, the cationic surfactant comprises cetyltrimethylammonium bromide (CTAB). In some embodiments, the cationic surfactant comprises a hydrophobic moiety. In some embodiments, the hydrophobic moiety comprises an alkyl group comprising at least 2, at least 5, at least 10, at least 12, at least 14, at least 16, at least 18, at least 20, at least 22, at least 24, or at least 25 carbon atoms. In some embodiments, the cationic surfactant comprises a hydrophilic group comprising any of a variety of salts. In some embodiments, the hydrophilic group comprises a quaternary ammonium salt. That is, the hydrophilic group comprises a positively-charged ion of the general structure [NR₄]⁺ where R is an alkyl group, an aryl group, or an organyl group and can ionically interact with halogens (e.g., fluorine, chlorine, bromine, iodine).

In some embodiments, the surfactant comprises an anionic and/or a non-ionic surfactant. The anionic surfactant comprises, in some embodiments, a portion having a net negative charge. In some embodiments, the non-ionic surfactants may not have net charge. In certain embodiments, the anionic and/or non-ionic surfactants may allow for the removal of long-chain PFAS molecules and/or other contaminants, and may have a relatively lower cost than surfactants that remove short-chain PFAS molecules. Accordingly, in some embodiments, the anionic and/or non-ionic surfactant may, advantageously, be introduced into the feed, the vessel, the separator(s), or any input or output of the system to remove long-chain PFAS molecules, such that the cationic surfactant (which may have a relatively high cost) may be introduced afterward to target short-chain PFAS molecules to limit the consumption of the cationic surfactant by long-chain PFAS molecules. One example of such operation is shown, for example, in FIG. 12. In some embodiments, the anionic and/or non-ionic surfactants can be introduced as co-surfactants or as an alternative to the cationic surfactant. In some embodiments, the anionic and/or non-ionic surfactants can be introduced into the vessel, the separator(s), or any one of the various inputs and/or outputs described herein.

In some embodiments, the surfactant comprises one type of surfactant. In other embodiments, the surfactant comprises more than one type of surfactant. In some embodiments, the surfactant comprises a mixture of surfactants comprising the cationic surfactant, the anionic surfactant, and/or the non-ionic surfactant.

In some embodiments, the length of the largest alkyl group in the surfactant is similar in length to the largest alkyl group of the PFAS molecules. In some embodiments, the number of carbon atoms in the largest alkyl group in the cationic surfactant is within 10, within 9, within 8, within 7, within 6, within 5, within 4, within 3, within 2, or within 1 (or the same as) the number of carbon atoms in the largest alkyl group of the PFAS molecules.

The surfactant may be present in the membrane separator retentate input and/or the foam fractionation separator input in any of a variety of concentrations. In some embodiments, the feed comprises the surfactant in a relatively low concentration. The use of a relatively low concentration may be particularly advantageous as it reduces the capital expenditure needed to facilitate the removal of the PFAS molecules and reduces resources needed to remove the surfactant from the liquid prior to the liquid's intended use. In some embodiments, the membrane separator retentate input and/or the foam fractionation separator input comprises the surfactant at an amount of greater than or equal to 100 mg/L, greater than or equal to 150 mg/L, greater than or equal to 200 mg/L, greater than or equal to 300 mg/L, greater than or equal to 360 mg/L, greater than or equal to 500 mg/L, greater than or equal to 750 mg/L, or greater than or equal to 1000 mg/L. In some embodiments, the membrane separator retentate input and/or the foam fractionation separator input comprises the surfactant at an amount of less than or equal to 1000 mg/L, less than or equal to 750 mg/L, less than or equal to 500 mg/L, less than or equal to 360 mg/L, less than or equal to 300 mg/L, less than or equal to 200 mg/L, less than or equal to 150 mg/L, or less than or equal to 100 mg/L. Combinations of these ranges are possible (e.g., greater than or equal to 100 mg/L and less than or equal to 1000 mg/L, greater than or equal to 200 mg/L and less than or equal to 360 mg/L). Other ranges are also possible.

In some embodiments, the membrane separator retentate input and/or the foam fractionation separator input comprises the surfactant in an amount greater than or equal to the critical micelle concentration (CMC). That is, in some embodiments, the surfactant is present in the membrane separator retentate input and/or the foam fractionation separator input in an amount sufficient such that at least some of the PFAS molecules are associated with micelles comprising the surfactant. The CMC may vary based on various parameters including but not limited to temperature, valency of the counter-ion of the surfactant, the size of alkyl groups of the surfactant, and/or the presence of electrolytes in the membrane separator retentate input and/or the foam fractionation separator input. Accordingly, in some embodiments, these parameters may be varied such that the concentration of the surfactant in the membrane separator retentate input and/or the foam fractionation separator input is greater than or equal to the CMC. In some embodiments, the membrane separator retentate input and/or the foam fractionation separator input comprises the surfactant in an amount that is less than or equal to 5 times the CMC, less than or equal to 4 times the CMC, less than or equal to 3 times the CMC, less than or equal to 2 times the CMC, less than or equal to 1.5 times the CMC, and/or as low as 1.1 times the CMC, as low as 1.05 time the CMC, or less.

In some embodiments, the system comprises a total organic carbon (TOC) analyzer. In some embodiments, the TOC analyzer allows the amount of surfactant in any input or output of the system to be measured. The TOC analyzer may be in electrical communication with a dosing pump responsible for introducing the surfactant into any input or output of the system. Accordingly, the concentration of the surfactant in the vessel, or any input or output of the system may be increased, decreased, and/or maintained based on the electrical output of the TOC analyzer.

As mentioned elsewhere in this disclosure, the presence of the surfactant may allow at least some of the PFAS molecules to associate with a micelle. As used herein, when a PFAS molecule is “associated” with a micelle, the PFAS molecules is either part of the micelle or the PFAS molecule is otherwise associated with the micelle such that the PFAS molecule and the micelle move together in the system. For example, the PFAS molecules may be attached to an outer portion of the micelle such that the PFAS molecule and micelle move together. As another example, the PFAS molecule may be in an inner portion of the micelle such that the PFAS molecule and the micelle move together. In some embodiments, the micelles comprise the surfactant. In some embodiments, the PFAS molecules and the surfactant may interact (e.g., electrostatically) such that the PFAS molecules and the surfactant arrange into a micellular structure.

In some embodiments, the surfactant may allow for the formation of micelles with which the PFAS molecules are associated. In some embodiments, micelles comprising surfactant and associated with PFAS molecules may be advantageously removed from a liquid via a fluidic device (e.g., the membrane separator comprising the semi-permeable membrane). Accordingly, as PFAS molecules associate with a micelle, the removal of the PFAS molecules from the liquid may be facilitated. In some embodiments, the micelles comprise the surfactant. Some of the PFAS molecule may electrostatically interact with the surfactant. For example, anionic portions of PFAS molecules may electrostatically interact with cationic portions of the surfactant thereby allowing a relatively stable micelle that comprises both the surfactant and PFAS to form. The relative stability of the micelles may facilitate the removal at least some of the PFAS molecules from the liquid as the micelles may withstand removal from the liquid by the membrane separator and/or the foam fractionation separator. Additionally, the electrostatic interaction between the surfactant and some of the PFAS molecules may allow for the formation of relatively large micelles which may further facilitate the removal of PFAS molecules from the liquid.

In some embodiments, at least some of the micelles have a relatively large molecular weight which can advantageously facilitate removal of PFAS molecules from the liquid. In some embodiments, at least some (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of the micelles have a molecular weight greater than or equal to 100 dalton (Da), greater than or equal to 500 Da, greater than or equal to 750 Da, greater than or equal to 1000 Da, greater than or equal to 1500 Da, greater than or equal to 2000 Da, greater than or equal to 2500 Da, or greater than or equal to 3000 Da. In some embodiments, at least some (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 90 wt %, up to 95 wt %, up to 99 wt %, or up to 100 wt %) of micelles have a molecular weight less than or equal to 3000 Da, less than or equal to 2500 Da, less than or equal to 2000 Da, less than or equal to 1500 Da, less than or equal to 1000 Da, less than or equal to 750 Da, less than or equal to 500 Da, or less than or equal to 100 Da. Combinations of these ranges are possible (e.g., greater than or equal to 100 Da and less than or equal to 3000 Da). Other ranges are also possible.

As noted above, some embodiments comprise transporting a membrane separator retentate input to a retentate side of a membrane separator. A membrane separator refers to a collection of components including one or more semi-permeable membranes configured to perform a membrane-based separation process (e.g., an osmotic process, a filtration process, or a combination thereof) on at least one input and produce at least one output. The membrane separator may comprise at least one semi-permeable membrane defining a permeate side of the membrane separator and a retentate side of the membrane separator. Each membrane separator described herein may include further sub-units such as, for example, individual semi-permeable membrane modules (e.g., in the form of cartridges), valving, fluidic conduits, and the like. As described in more detail below, each membrane separator can include a single semi-permeable membrane or multiple semi-permeable membranes. In some embodiments, a single membrane separator can include multiple sub-units (e.g., multiple modules such as multiple cartridges) that may or may not share a common container. In some embodiments, the system includes two or more membrane separators fluidically connected to each other.

In some embodiments, a membrane separator retentate input is transported to a retentate side of the membrane separator such that the membrane separator retentate output exits the retentate side of the membrane separator, the membrane separator retentate output having concentration of the PFAS molecules that is greater (e.g., by a factor of at least 1.03, at least 1.035, at least 1.05, at least 1.10, at least 1.25, at least 1.40, at least 1.50, at least 2, at least 3, at least 4, at least 5, at least 10, and/or up to 20, up to 50, or greater) than the concentration of the PFAS molecules of the membrane separator retentate input.

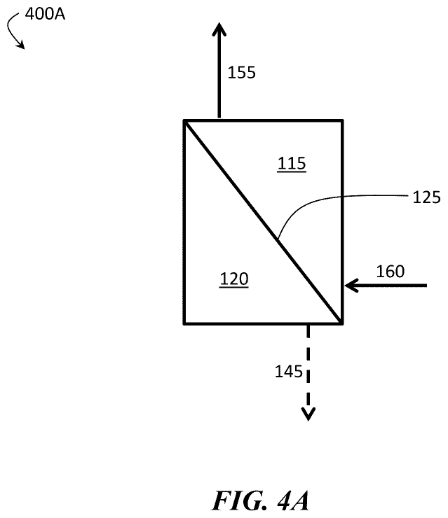

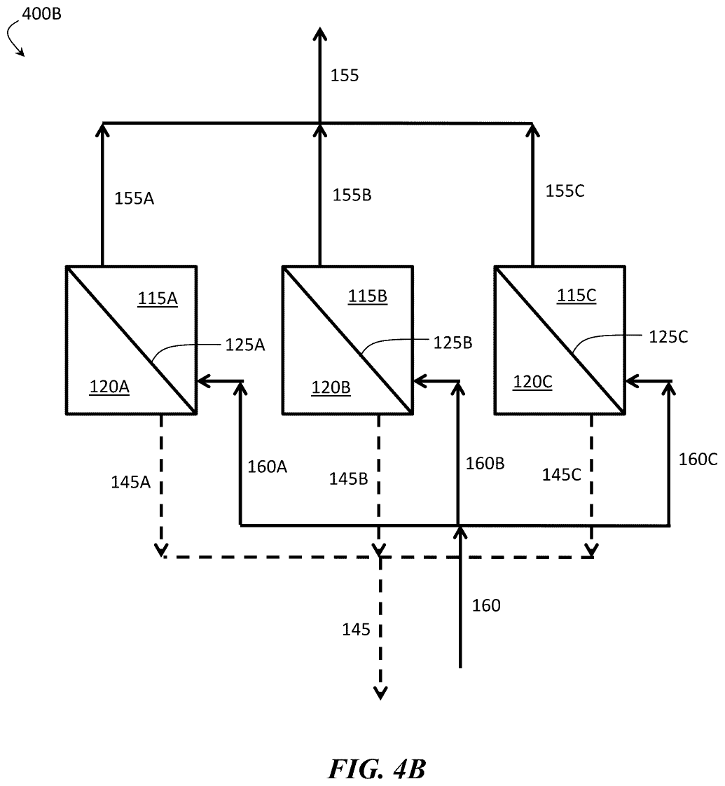

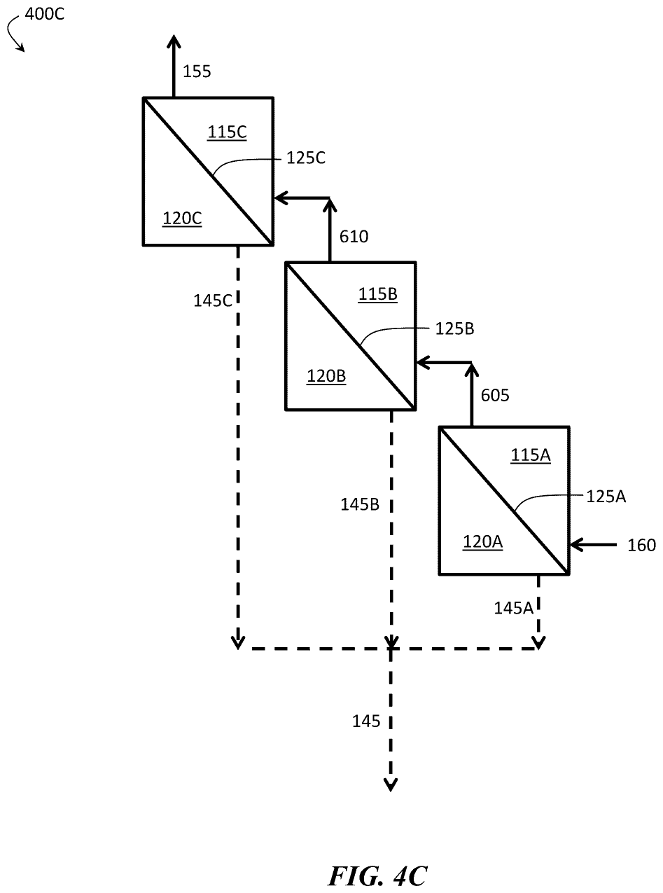

FIG. 4A is a schematic illustration of membrane separator 400A, in which a single semi-permeable membrane is used to separate permeate side 120 from retentate side 115. Membrane separator 400A can be operated by transporting membrane separator retentate input 160 across retentate side 115. At least a portion (e.g., at least 5 wt %, at least 10 wt %, at least 20 wt %, at least 50 wt %, and/or up to 60 wt %, up to 70 wt %, up to 80 wt %, and/or up to 90 wt %, or more) of a liquid (e.g., a solvent) within membrane separator retentate input 160 can be transported across semi-permeable membrane 125 to permeate side 120. This can result in the formation of membrane separator retentate output 155, which can include a higher concentration of solute (e.g., the PFAS molecules) than is contained within membrane separator retentate input 160, as well as membrane separator permeate output 145. In some embodiments, membrane separator permeate output 145 can correspond to the liquid (e.g., solvent) of membrane separator retentate input 160 that was transported from retentate side 115 to permeate side 120. Membrane separator permeate output 145 may also include some solute (e.g., the PFAS molecules), although it will generally contain much less solute due to the solute being selectively excluded from being transported through semi-permeable membrane 125.

In some embodiments, the membrane separator comprises a plurality of semi-permeable membranes. In some such embodiments, the plurality of semi-permeable membranes within the membrane separator are connected in series. In some such embodiments, the plurality of semi-permeable membranes within the membrane separator are connected in parallel. In certain embodiments, the membrane separator comprises a plurality of membranes a first portion of which are connected in series and another portion of which are connected in parallel.

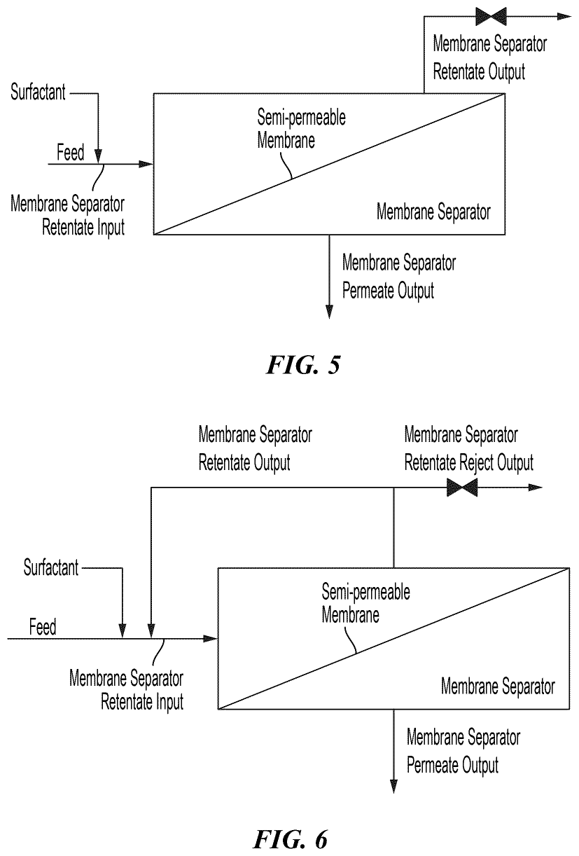

In some embodiments, a membrane separator comprises a plurality of semi-permeable membranes connected in parallel. One example of such an arrangement is shown in FIG. 4B. In FIG. 4B, membrane separator 400B comprises three semi-permeable membranes 125A, 125B, and 125C arranged in parallel. Membrane separator retentate input 160 is split into three sub-inputs (160A, 160B, and 160C), with one sub-input fed to retentate side 115A of semi-permeable membrane 125A, another sub-input fed to retentate side 115B of semi-permeable membrane 125B, and yet another sub-input fed to retentate side 115C of semi-permeable membrane 125C. Membrane separator 400B can be operated by transporting the membrane separator retentate input sub-inputs across the retentate sides of the semi-permeable membranes. At least a portion of a liquid (e.g., a solvent) within membrane separator retentate input 160 can be transported across each of semi-permeable membranes 125A, 125B, and 125C to permeate sides 120A, 120B, and 120C, respectively. This can result in the formation of three retentate output sub-outputs (155A, 155B, and 155C), which can be combined to form membrane separator retentate output 155. Membrane separator retentate output 155 can include a higher concentration of solute (e.g., the PFAS molecules) than is contained within membrane separator retentate input 160. Membrane separator permeate output 145 can also be formed (from three permeate output sub-outputs 145A, 145B, and 145C). Membrane separator permeate output 145 can correspond to the liquid (e.g., solvent) of membrane separator retentate input 160 that was transported from retentate sides 115A-115C to permeate sides 120A-120C. Membrane separator permeate output 145 may also include some solute (e.g., the PFAS molecules), although it will generally contain much less solute due to the solute being selectively excluded from being transported through semi-permeable membrane 125. In some embodiments, as mentioned elsewhere in this disclosure, some or all of the membrane separator retentate output may be incorporated into the membrane separator retentate input and/or diverted (e.g., rejected) for subsequent destruction (see FIGS. 5-6).

While FIG. 4B shows three semi-permeable membranes connected in parallel, other embodiments could include 2, 4, 5, or more semi-permeable membranes connected in parallel. In some embodiments, the semi-permeable membranes are fluidly connected to each other.

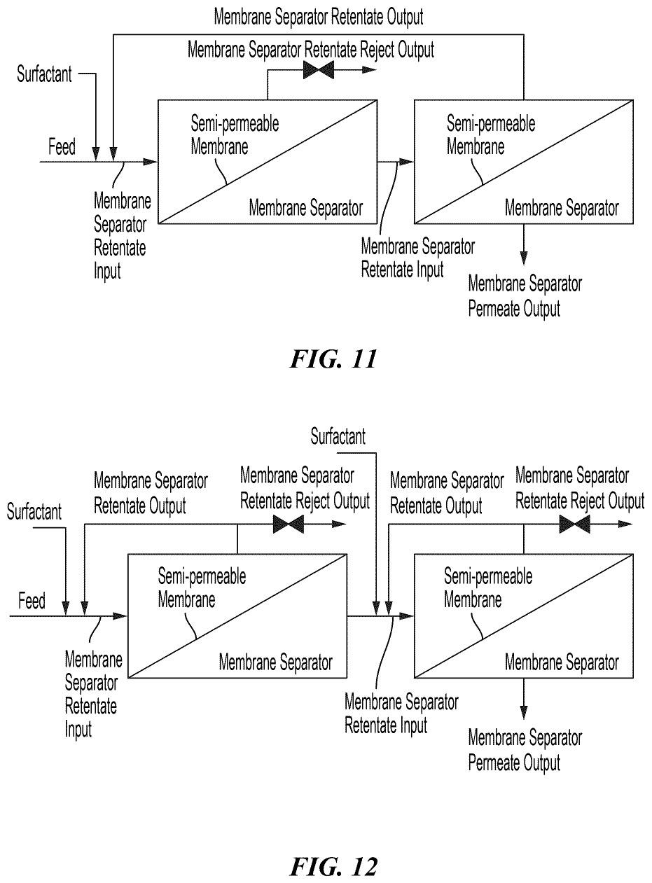

In some embodiments, a membrane separator comprises a plurality of semi-permeable membranes connected in series. One example of such an arrangement is shown in FIG. 4C. In FIG. 4C, membrane separator 400C comprises three semi-permeable membranes 125A, 125B, and 125C arranged in series. In FIG. 4C, membrane separator retentate input 160 is first transported to retentate side 115A of semi-permeable membrane 125A. At least a portion of a liquid (e.g., a solvent) within membrane separator retentate input 160A can be transported across semi-permeable membrane 125A to permeate side 120A of semi-permeable membrane 125A. This can result in the formation of membrane separator permeate output 145A and first intermediate retentate output 605 that is transported to retentate side 115B of semi-permeable membrane 125B. At least a portion of a liquid (e.g., a solvent) within first intermediate retentate output 605 can be transported across semi-permeable membrane 125B to permeate side 120B of semi-permeable membrane 125B. This can result in the formation of membrane separator permeate output 145B and second intermediate retentate output 610 that is transported to retentate side 115C of semi-permeable membrane 125C. At least a portion of a liquid (e.g., a solvent) within second intermediate retentate output 610 can be transported across semi-permeable membrane 125C to permeate side 115C of semi-permeable membrane 125C. This can result in the formation of permeate output 145C and membrane separator retentate output 155. Other examples of semi-permeable membranes connected in series are shown FIGS. 10-11, in accordance with certain embodiments.

While FIG. 4C shows three semi-permeable membranes connected in series, other embodiments could include 2, 4, 5, or more semi-permeable membranes connected in series. In some embodiments, the semi-permeable membranes are fluidly connected to each other.

For membrane separators comprising a plurality of semi-permeable membranes, parameters such as relative concentrations for the membrane separator input and output streams are calculated by performing a mass balance on the entire membrane separator.

As mentioned above, each membrane separator of the system may comprise at least one semi-permeable membrane. In general, a semi-permeable membrane is a barrier that allows some components of a mixture to pass through while blocking at least some of the other components (e.g., blocking all of another component, or reducing the relative rate of permeation of another component). For example, a semi-permeable membrane may block some molecules in a mixture (e.g., PFAS and associated micelles) from passing through while allowing others (e.g., solvent molecules) to pass through. In some instances, a semi-permeable membrane blocks some molecules and permits other molecules to pass through based on their molecular weight and/or charge.

As noted above, a semi-permeable membrane can be used for osmotic processes. For example, the semi-permeable membrane may be an osmotic membrane. An osmotic membrane may be capable of producing an osmotic pressure difference between solutions on either side of the membrane upon application of a hydraulic pressure difference across the two sides of the membrane. For example, if an osmotic membrane is placed between two solutions of identical composition such that there is initially no osmotic pressure difference across the membrane, application of a hydraulic pressure difference across the osmotic membrane may allow for transport of components from one side of the membrane to the other such that an osmotic pressure difference across the two sides of the membrane is established. Semi-permeable membranes may also be used for nanofiltration processes. Semi-permeable membranes may be configured for osmotic processes, nanofiltration processes, and/or processes in which separation is achieved based on a combination of nanofiltration and osmotic mechanisms (e.g., based on, for example, the molecular weight cutoff of the membranes, pore sizes of the membranes, the nature of the mixtures to which they are exposed, and a magnitude of applied hydraulic pressure).

The semi-permeable membrane medium can comprise, for example, a metal, a ceramic, a polymer (e.g., polyamides, polyethylenes, polyesters, poly(tetrafluoroethylene), polysulfones, polycarbonates, polypropylenes, poly(acrylates)), and/or composites or other combinations of these. The semi-permeable membranes generally allow for the selective transport of solvent (e.g., water) through the membrane while solute (e.g., PFAS and associated micelles) are inhibited from being transported through the membrane. Examples of commercially available semi-permeable membranes that can be used in association with certain of the embodiments described herein include, but are not limited to, those commercially available from Dow Water and Process Solutions (e.g., FilmTec™ membranes), Hydranautics, GE Osmonics, Suez, LG, Toyobo, Microdyn, and Toray Membrane, among others.

In some embodiments, the semi-permeable membrane is a super-filtration membrane. That is, the semi-permeable membrane may have a molecular weight cutoff greater than or equal to 200 Da and less than or equal to 5000 Da. In some embodiments, super-filtration membranes may advantageously allow for the removal of micelles (e.g., PFAS and associated micelles) while generally limiting the amount of the PFAS molecules, the surfactant, and/or the micelles that permeate through the semi-permeable membrane. In some cases, other types of membranes, such as ultrafiltration membranes, may not substantially prevent the transport of the PFAS molecules from the retentate side of the membrane separator to the permeate side of the membrane separator.

In some embodiments, the semi-permeable membrane has a molecular weight cutoff (MWCO). In some embodiments, the MWCO of the semi-permeable membrane is greater than or equal to 200 Da, greater than or equal to 500 Da, greater than or equal to 1000 Da, greater than or equal to 1500 Da, greater than or equal to 2000 Da, greater than or equal to 2500 Da, greater than or equal to 3000 Da, greater than or equal to 3500 Da, greater than or equal to 4000 Da, greater than or equal to 4500 Da, or greater than or equal to 5000 Da. In some embodiments, the MWCO of the semi-permeable membrane is less than or equal to 5000 Da, less than or equal to 4500 Da, less than or equal to 4000 Da, less than or equal to 3500 Da, less than or equal to 3000 Da, less than or equal to 2500 Da, less than or equal to 2000 Da, less than or equal to 1500 Da, less than or equal to 1000 Da, less than or equal to 500 Da, or less than or equal to 200 Da. Combinations of these ranges are possible (e.g., greater than or equal to 200 Da and less than or equal to 5000 Da). Other ranges are also possible.

In some embodiments, the semi-permeable membrane comprises a neutral-charged membrane. In some embodiments, the neutral-charged membrane comprises a zwitterionic membrane. That is, the semi-permeable membrane may comprise zwitterions that facilitate the transport of some or all of the membrane separator retentate input from the retentate side of the membrane separator, to the permeate side of the membrane separator while limiting the transport of organic components (e.g., organic compounds or amphiphilic compounds). In some embodiments, the zwitterionic membrane comprises zwitterionic polymers. In some embodiments, the zwitterionic polymers are disposed onto the semi-permeable membrane and/or grafted or adsorbed onto the semi-permeable membrane. In some embodiments, the zwitterionic polymers are associated with the semi-permeable membrane via covalent interactions and/or non-covalent interactions (e.g., van der waals forces). An example of a zwitterionic membrane include those manufactured by ZwitteiCo.

The semi-permeable membrane can comprise any of a variety of suitable properties. In some embodiments, the semi-permeable membrane comprises one or more hydrophilic surfaces. The one or more hydrophilic surfaces, in accordance with certain embodiments, can facilitate the transport of the liquid from the retentate side of the membrane separator, through the semi-permeable membrane, to the permeate side of the membrane separator. In some embodiments, the semi-permeable membrane comprises anti-fouling properties. In some cases, semi-permeable membranes may foul during use thereby reducing, or occasionally preventing, transport of the liquid from the retentate side of the membrane separator to the permeate side of the membrane separator. Accordingly, in some embodiments, the semi-permeable membrane has anti-fouling properties (e.g., an anti-fouling coating) that may advantageously allow for relatively high throughputs associated with liquid transport through the semi-permeable membrane. In some embodiments, the semi-permeable membrane allows for the transport of the liquid from the retentate side of the membrane separator to the permeate side of the membrane separator despite relatively high concentrations of the surfactant in the liquid. That is, the semi-permeable may be able to continue to transport the liquid such that the semi-permeable does not fully clog and/or foul. In some embodiments, the semi-permeable membrane has a relatively narrow pore size distribution. In some embodiments, the semi-permeable membrane comprises pores such that each pore has a volume that is within at least 1%, at least 5%, at least 10%, at least 15%, at least 20%, at least 25%, at least 30%, at least 35%, at least 40%, at least 45%, or at least 50% of each other. Pore size distribution of the semi-permeable membrane can be measured via gel permeation chromatography (GPC).

In some embodiments, the concentration of the PFAS molecules in the membrane separator permeate output is lower than the concentration of the PFAS molecules in the membrane separator retentate output. In some embodiments, the concentration of the PFAs molecules in the membrane separator permeate output is at least 30%, at least 40%, at least 50%, at least 60%, at least 70%, at least 80%, at least 90%, at least 95%, at least 97.5%, and/or at least 99% lower than the concentration of the PFAS molecules in the membrane separator retentate output.

In some embodiments, the concentration of the PFAS molecules in the membrane separator permeate output is lower than the concentration of the PFAS molecules in the membrane separator retentate input. In some embodiments, the concentration of the PFAS molecules in the membrane separator permeate output is at least 30%, at least 40%, at least 50%, at least 60%, at least 70%, at least 80%, at least 90%, at least 95%, at least 97.5%, and/or at least 99% lower than the concentration of the PFAS molecules in the membrane separator retentate input.

In some embodiments, at least a portion of a membrane separator retentate output is recirculated (e.g., to be transported to the retentate side of an upstream membrane separator or the same membrane separator). As one example, at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, and/or up to 85 wt %, up to 90 wt %, up to 95 wt %, up to 99 wt %, or up to 100 wt %) of the membrane separator retentate output may be recirculated (e.g., via a recycling process) such that the membrane separator retentate input comprises at least a portion of the membrane separator retentate output. For example, in FIGS. 1C-1D, all of membrane separator retentate output 155 is recirculated (via vessel 175) such that membrane separator retentate input 160 comprises the first membrane separator retentate output 155. In some embodiments, the membrane separator is configured to continuously output the membrane separator retentate output. In some embodiments, the membrane separator is configured to intermittently output the membrane separator retentate output.

In some embodiments, such as during certain of the batch processes described below, the recirculation described above comprising at least a portion of the membrane separator retentate output is not mixed with the feed prior to or during incorporation of that portion of the membrane separator retentate output into the membrane separator retentate input. For example, in some embodiments, during at least a period of time during the liquid removal process, the membrane separator retentate input comprises none of the membrane separator retentate output or it comprises less than or equal to 20 wt %, less than or equal to 10 wt %, less than or equal to 5 wt %, less than or equal to 2 wt %, less than or equal to 1 wt %, or less than or equal to 0.1 wt % of the membrane separator retentate output.

During a recycle process, in accordance with some embodiments, at least some (or all) of a remainder of the membrane separator retentate output not recirculated back to the retentate side of the membrane separator can become a part (or all) of a concentrated output. In some embodiments, a hydraulic pressure of the recirculation of the membrane separator retentate output is increased (e.g., by at least 5%, at least 10%, at least 20%, at least 50%, at least 80%, at least 90%, at least 95%, at least 99%, or more) prior to becoming part of the membrane separator retentate input. Such an increase in pressure can be accomplished using any of a variety of techniques, such as using a pump.

In some instances, a recycle process involving the membrane separator (e.g., incorporating a portion of the membrane separator retentate output into the first membrane separator retentate input) is performed in a batch manner. In some embodiments, a recycle process is performed in a continuous manner. In some embodiments, a recirculation process is performed using a semi-batch process. During batch operation, a hydraulic pressure of the membrane separator retentate input is increased over time during operation, as quantities of the input are fed to the retentate side input. It has been realized in the context of this disclosure that batch or semi-batch operation of a process involving a membrane separator (e.g., a recycle process) can reduce an amount of energy required to operate the membrane separator by gradually increasing a concentration (and in some instances the hydraulic pressure) of the membrane separator retentate input rather than maintaining an entirety of the membrane separator inputs and/or outputs at a high pressure, as is generally the case during continuous operation. Such a reduction in energy usage may allow for the PFAS molecules to be recovered (e.g., for eventual destruction) with greater energy efficiency and/or lower cost than typical existing PFAS removal technologies.

In some embodiments, the membrane separator retentate input comprises at least a portion of the membrane separator retentate output. For example, in FIG. 1C, membrane separator retentate input 160 comprises at least a portion of membrane separator retentate output 155. Accordingly, since the membrane separator retentate input may comprise at least a portion of the membrane separator retentate output, the membrane separator retentate output may be advantageously recycled through the membrane separator thereby enhancing separation of the PFAS molecules from remaining liquid in the membrane separator retentate output. As the membrane separator retentate output is recycled into the membrane separator, the concentration of the PFAS molecules in the membrane separator retentate output may increase as the liquid is removed (e.g., by permeating the semi-permeable membrane to the permeate side of the membrane separator). In some embodiments, this advantageously reduces the amount of the liquid that may need to be discarded during the removal and/or subsequent destruction of the PFAS molecules.

As noted above, certain of the systems and the methods described herein involve the use of a foam fractionation separator. For example, in FIG. 1A, system 100 comprises foam fractionation separator 130 configured to receive foam fractionation separator input 135 and configured to output foam fractionated recovery output 140 and foam fractionated product output 150. In some embodiments, the foam fractionation separator is a fluidic device that induces formation of a foam (e.g., via agitation and/or the introduction of gas and/or surfactants via one or more inlets) in at least a portion of the contents of the foam fractionation separator. The foam, after formation, may rise above any remaining liquid, and/or other components of the input, that cannot participate in foam formation. That is, the foam may be present as a separate domain from the remaining liquid (e.g., a first domain comprising the foam may be separate from a second domain comprising the liquid) within the foam fractionation separator. Accordingly, in some embodiments, the foam is collected and outputted from the foam fractionation separator. For example, in FIG. 1A, foam fractionated recovery output 140 may comprise foam formed by the foam fractionation separator. In some embodiments, at least a portion of the remaining contents of the foam fractionation separator that did not participate in foam formation is outputted from the foam fractionation separator. For example, in FIG. 1B, foam fractionated product output 150 is outputted from foam fractionation separator 130. In some embodiments, the foam fractionation separator comprises a vessel that facilitates foam formation and/or the separation of foam from any remaining content within the foam fractionation separator.

In some embodiments, the foam fractionation separator input undergoes a single foam fractionation cycle. That is, the foam fractionation separator input may undergo foam fractionation before at least a portion of the contents within the foam fractionation separator may be diverted to the foam fractionated recovery output for further processing (i.e., processing not related to foam fractionation) or the foam fractionated product output for further processing (i.e., processing not related to foam fractionation). In some embodiments, the foam fractionation separator is downstream from the membrane separator. In some embodiments, the foam fractionation separator is upstream from the membrane separator.

In some embodiments, the foam fractionation separator input undergoes more than one foam fractionation cycle. That is, the contents of the foam fractionation separator input may undergo foam fractionation before a portion of a foam fractionated output (e.g., the foam fractionated recovery output and/or the foam fractionated product output) may be diverted into the foam fractionation separator input of the same foam fractionation separator or another foam fractionation separator. In some embodiments, the foam fractionation cycles are carried out by a single foam fractionation separator. In other cases, the foam fractionation cycles are carried out by multiple foam fractionation separators. For example, a first foam fractionation cycle may be carried out by a first foam fractionation separator that outputs a first foam fractionated recovery output, and a second foam fractionation separator may input a second foam fractionation separator input comprising at least a portion of the first foam fractionated recovery output to implement a second foam fractionation cycle. The second foam fractionated recovery output may comprise contaminants (e.g., PFAS and/or the surfactant) in a higher concentration than the first foam fractionated recovery output. In some embodiments, the foam fractionation separator input comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, at least 90 wt %, at least 95 wt %, at least 99 wt %, or more) of the foam fractionated recovery output and/or the foam fractionated product output.

While the foam fractionation separator input may undergo one or more foam fractionation cycles, as the foam fractionation separator input becomes progressively more concentrated, it may be challenging to liquify and/or transport the foam fractionation separator input into the foam fractionation unit. Accordingly, in some embodiments, the membrane separator, in lieu of one or more foam fractionation cycles, can advantageously remove the PFAS molecules from a relatively concentrated membrane separator retentate input.

In some embodiments, the foam fractionation separator comprises one or more inlets. In some embodiments, the one or more inlets allow the foam fractionation separator to receive the foam fractionation separator input. In some embodiments, the foam fractionation separator comprises one or more inlets fluidically connected to the permeate side of the membrane separator. For example, in FIG. 1A, foam fractionation separator input 135 is fluidically connected to permeate side 120 of membrane separator 110 via inlet 165.

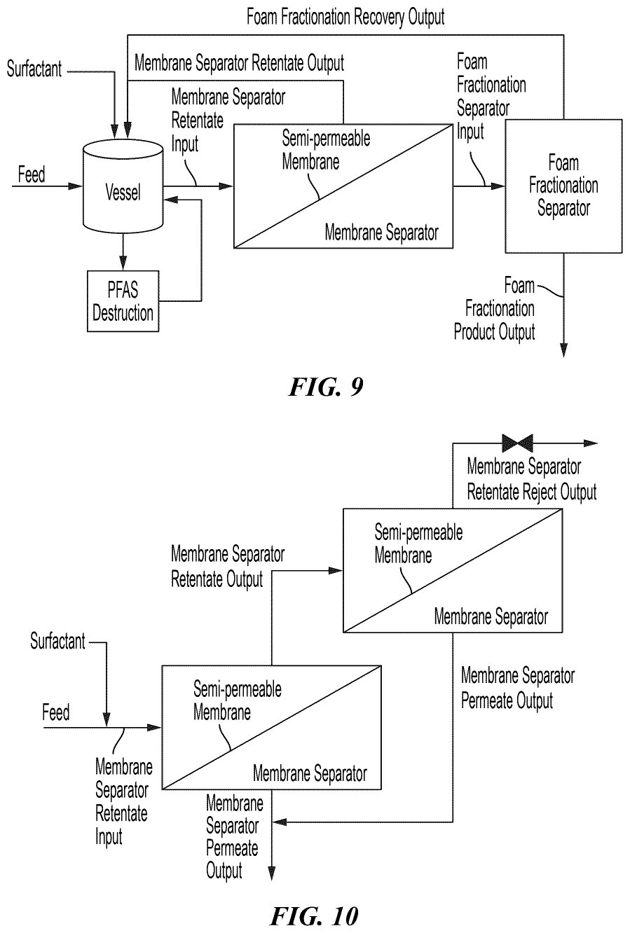

In some embodiments, the one or more inlets of the foam fractionation separator are configured to receive a foam fractionation separator input. For example, in FIG. 1A, foam fractionation separator 130 receives foam fractionation separator input 135 via inlet 165. In some embodiments, the foam fractionation separator input comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %, at least 90 wt %, at least 95 wt %, at least 99 wt %, or up to 100 wt %) of the membrane separator permeate output. In some embodiments, the foam fractionation separator may remove any remaining contaminants that may be present in the membrane separator permeate output. Accordingly, the foam fractionation separator input may be in fluidic communication with a portion of the membrane separator permeate output (see FIGS. 8 and 9).

In some embodiments, the one or more inlets are configured to receive a foam fractionation separator input. For example, in FIG. 2A, foam fractionation separator 130 may receive foam fractionation separator input 135 via inlet 165. In some embodiments, the foam fractionation separator input comprises the liquid and the PFAS molecules. In some embodiments, the foam fractionation separator input may comprise contaminants (e.g., the PFAS molecules) in a relatively low concentration. After foam fractionation of the contents of the foam fractionation separator input, the foam fractionated recovery output may have a relatively high concentration of contaminants, such as the PFAS molecules. When the membrane separator retentate input comprises a portion of the foam fractionated recovery output having a relatively high concentration of the PFAS molecules, removal of the PFAS molecules by the membrane separator may be advantageously efficient. Accordingly, in some embodiments, the membrane separator retentate input comprises at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %) of the foam fractionated recovery output.

In some embodiments, the foam fractionation separator comprises the one or more inlets wherein at least one inlet is configured to receive a foam fractionation separator input from the permeate side of the membrane separator. In some embodiments, the foam fractionation separator input comprises a portion of the membrane separator permeate output. For example, in FIG. 1A, foam fractionation separator input 135 comprises all of membrane separator permeate output 145. In some embodiments, the membrane separator permeate output may have a relatively high concentration of the PFAS molecules, and the foam fractionation separator may facilitate the removal and further concentration of the PFAS molecules. Accordingly, in some embodiments, the foam fractionation separator input entering the foam fractionation separator comprises at least a portion of the membrane separator permeate output.

In some embodiments, the foam fractionation separator comprises one or more outlets. In some embodiments, one or more outlets are configured to output the foam fractionated recovery output. In some embodiments, the foam fractionated recovery output comprises at least some of the PFAS molecules and some of the liquid. In some embodiments, the foam fractionated recovery output comprises at least some of the PFAS molecules, some of the liquid, and some of the surfactant. As mentioned elsewhere in the present disclosure, the foam fractionated recovery output may have a relatively high concentration of the PFAS molecules. Accordingly, given its relatively high concentration of the PFAS molecules, at least a portion (e.g., at least 5 wt %, at least 10 wt %, at least 20 wt %, at least 50 wt %, at least 80 wt %, at least 90 wt %, at least 95 wt %, at least 99 wt %, at least 99.9 wt %, or 100 wt %) of the foam fractionated recovery output may undergo a destruction process (e.g., a hydrothermal process configured to destroy some PFAS molecules) and/or further concentration processes (e.g., using another foam fractionation separator or the membrane separator). In some embodiments, the foam fractionated recovery output comprises the PFAS molecules, the surfactant, and the liquid.

In some embodiments, the membrane separator retentate input comprises at least a portion of the foam fractionated recovery output. For example, in FIG. 1B, system 100 comprises membrane separator 110 outputting membrane separator permeate output 145 such that membrane separator retentate input 160 comprises at least a portion of foam fractionated recovery output 140. Foam fractionation separator 130 outputs foam fractionated recovery output 140. As described elsewhere in this disclosure, the foam fractionation separator, in some embodiments, can concentrate the PFAS molecules for subsequent removal by the membrane separator. Accordingly, as the membrane separator retentate input may comprise at least a portion of the foam fractionated recovery output, the membrane separator may remove and/or further concentrate any remaining PFAS that has been concentrated by the foam fractionation separator. Such recycling of the foam fractionated recovery output may facilitate concentration of the PFAS molecules. In some embodiments, this advantageously reduces the amount of the liquid that may need to be discarded during PFAS removal.

In some embodiments, one or more outlets are configured to output a foam fractionated product output. In some embodiments, the foam fractionated product output comprises a lower concentration of PFAS molecules than the foam fractionation separator input. As the contents of the foam fractionation separator input undergoes foam fractionation, some of the contents, often times a portion comprising a relatively low concentration of PFAS, may exit the foam fractionation separator via the foam fractionated product output. The foam fractionated product output may then be subject to additional processing (e.g., inputting into one or more foam fractionation separators and/or membrane separators) or be used for their intended application (e.g., urban, agricultural, environmental, or industrials applications and/or for consumption).

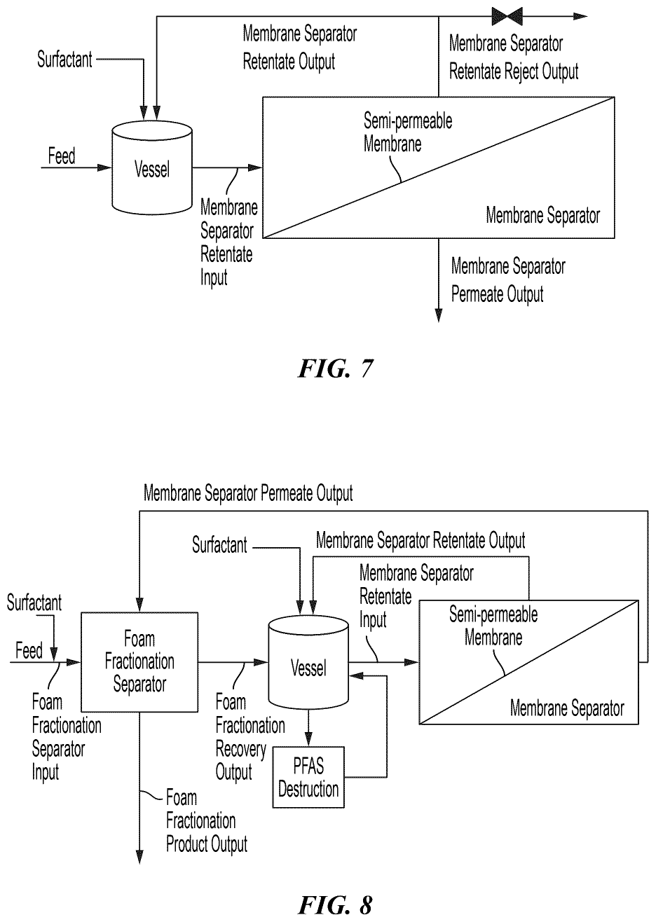

As noted above, certain of the systems and the methods described in the present disclosure involve a vessel. In some embodiments, the vessel comprises an equalization tank, a variable-volume tank, and/or a bladder. The vessel, in some embodiments, may facilitate the removal of the PFAS molecules by providing a relatively steady source of the liquid, the PFAS molecules, and/or the surfactant to either the membrane separator, the foam fractionation separator, or both. Additionally, the vessel may agitate its contents such that the contents are dispersed approximately uniformly throughout the interior of the vessel. In some embodiments, additives, such as the surfactant, are introduced and/or incorporated (e.g., by mixing, agitation, or the like) into the contents of the vessel. In some embodiments, the vessel comprises a stirrer, an agitator, an impeller and/or other devices capable of mixing the contents of the vessel. In some embodiments, a portion of the surfactant is dosed into the vessel such that it is incorporated with the contents of the vessel (see FIG. 7).

In some embodiments, the vessel comprises one or more inlets. In some embodiments, at least one inlet is fluidically connected to the foam fractionated recovery output. In some embodiments, some of the one or more inlets are configured to receive at least a portion of the foam fractionated recovery output. For example, in FIG. 1D, foam fractionated recovery output 140 is received by inlet 190 on vessel 175. As described elsewhere in this disclosure, a portion of the foam fractionated recovery output may be reintroduced into the foam fractionation separator and/or the membrane separator to the further concentrate contaminants (e.g., the PFAS molecules). Accordingly, the vessel may store a portion of the foam fractionated recovery output, along with other contents in some cases, such that the portion of the foam fractionated recovery output may be further processed by such fluidic devices. As a further example, as shown in FIG. 2B, vessel 175 is configured to receive foam fractionated recovery output 140 via inlet 190 to facilitate the recirculation and/or the recycling of foam fractionated recovery output 140.

In some embodiments, at least one inlet of the vessel is fluidically connected to the retentate side of the membrane separator. In some embodiments, at least one inlet of the vessel is configured to receive at least a portion of the membrane separator retentate output. For example, as shown in FIG. 1D, membrane separator retentate output 155 is received by vessel 175 via inlet 180. As another example, as shown in FIG. 2B, vessel 175 comprises inlet 180 fluidically connected to membrane separator retentate output 155. As described elsewhere in this disclosure, the membrane separator retentate output may have a relatively high concentration of the PFAS molecules and may undergo further processing (e.g., to further concentrate the PFAS molecules) using at least one foam fractionation separator, at least one membrane separator, or both. Accordingly, the vessel may store a portion of the membrane separator retentate output, along with other contents in some cases, such that the membrane separator retentate output may be further processed by such fluidic devices.

In some embodiments, the vessel comprises at least one inlet configured to receive the feed. For example, in FIGS. 1C-1D, feed 105 is received by vessel 175 via inlet 185. As mentioned previously, the vessel may allow for a relatively steady source of the liquid and the PFAS molecules to be introduced into the fluidic devices described throughout this disclosure (e.g., the foam fractionation unit and/or the membrane separation unit). Accordingly, the contents of the feed may be stored in the vessel prior to removal of the PFAS molecules by the membrane separator.

In some embodiments, the vessel comprises one or more outlets. For example, as shown in FIGS. 1C-1D, system 100 includes vessel 175 comprising outlet 195 configured to output a portion of membrane separator retentate input 160. For example, in FIG. 2B, vessel 175 comprises outlet 195 configured to output a portion of membrane separator retentate input 160. In some embodiments, the vessel comprises one or more outlets configured to output one or more inputs to one or more membrane separators.

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. Two membrane separators connected by a valve and conduits that permit flow between the membrane separators in at least one configuration of the valve would be said to be fluidically connected to each other. To further illustrate, two membrane separators that are connected by a valve and conduits that permit flow between the membrane separators in a first valve configuration but not a second valve configuration are considered to be fluidically connected to each other both when the valve is in the first configuration and when the valve is in the second configuration. In contrast, two membrane separators that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, at least 98 wt %, or up to 100 wt %) of the material (e.g., liquid, surfactant, PFAS, etc.) in the first region is transported to the second region via the direct fluidic connection. Any of the fluidic connections described herein may be, in some embodiments, direct fluidic connections. In other cases, the fluidic connections may be indirect fluidic connections.

While FIGS. 1A-1D and 2A-2B include both a membrane separator and a foam fractionation separator, the use of a foam fractionation separator is optional, and in some embodiments, only the membrane separator may be used. One example of such an embodiment is shown in FIG. 5. In FIG. 5, a membrane separator retentate input comprising at least some surfactant, PFAS molecules, and the liquid enters the membrane separator comprising a semi-permeable membrane. A portion of the membrane separator retentate input is then output from the membrane separator via a membrane separator retentate output. Another portion of the membrane separator retentate input contacts the semi-permeable membrane and is transported through the semi-permeable membrane and exits via a membrane separator permeate output. The membrane separator retentate input also comprises a feed in FIG. 5.

Another example of an embodiment where the foam fractionation separator is optional is shown in FIG. 6. FIG. 6 is substantially the same as FIG. 5 except that a portion of the membrane separator retentate output is recycled and enters the membrane separator via the membrane separator retentate input. Another portion of the membrane separator retentate output may not be incorporated into the membrane separator retentate input for recycling, and accordingly, may form a membrane separator retentate reject output. The membrane separator retentate reject output is shown being rejected (e.g., exiting) from the system.

While FIGS. 1C-1D include a foam fractionation separator, a membrane separator, and a vessel. the use of a foam fractionation separator, as described previously, is optional. In some embodiments, the membrane separator can be used with the vessel without the foam fractionation separator. For example, as shown in FIG. 7, a membrane separator is used along with a vessel. Similar to FIG. 6, a membrane separator retentate output exiting the membrane separator is recycled such that a portion of the contents in the membrane separator retentate output enter the membrane separator retentate input. As shown in FIG. 7, a portion of the membrane separator retentate output enters the vessel which outputs the membrane separator retentate input comprising a portion of the membrane separator retentate output. FIG. 7 also shows a portion of the membrane separator retentate output that is not incorporated into the vessel and forms a membrane separator retentate reject output. In some embodiments, the surfactant is dosed into the vessel such that a portion of the surfactant enters the membrane separator via the membrane separator retentate input. Turning again to FIG. 7, a surfactant enters a vessel such that a portion of the surfactant exits the vessel via the membrane separator retentate input. A feed also enters the vessel such that the feed and the surfactant can exit the vessel and enter the membrane separator via the membrane separator retentate input.

In some embodiments, the system includes the foam fractionation separator, the vessel, and the membrane separator such that a portion of the PFAS molecules exits system for destruction. For example, as shown in FIG. 8, a foam fractionation separator input comprising PFAS molecules and the liquid enters the foam fractionation separator. The foam fractionated separator input also comprises a feed. A foam fractionated product output and a foam fractionated recovery output exit the foam fractionation separator. The foam fractionated recovery output enters the vessel, and surfactant is added into the vessel such that a membrane separator retentate input exiting the vessel comprises the PFAS molecules, the surfactant, and the liquid. A membrane separator retentate output, comprising a relatively concentrated stream of the PFAS molecules, enters the vessel such that the membrane separator retentate output is recycled. A membrane separator permeate output is also recycled such that the membrane separator permeate output enters the foam fractionation separator for additional processing. As further illustrated in FIG. 8, a portion of the PFAS molecules within the system may exit the vessel for subsequent PFAS destruction, and any portion of the PFAS molecules that have survived the PFAS destruction may be reintroduced to the vessel for further processing by the membrane separator and/or the foam fractionation separator.

Another example of a system that includes the foam fractionation separator, the vessel, and the membrane separator is shown in FIG. 9. FIG. 9 is substantially the same as FIG. 8 except that a feed comprising the PFAS molecules and the liquid enters the vessel, and the foam fractionation separator is positioned downstream from the membrane separator, as opposed to upstream as shown in FIG. 8.

As described above, in some embodiments, the membrane separator comprises one or more semi-permeable membranes connected in series. For example, FIG. 10, which is substantially the same as FIG. 4C except that FIG. 10 shows only two semi-permeable membranes as opposed to three as shown in FIG. 4C, depicts two semi-permeable membranes fluidically connected in series.

In some embodiments, two or more semi-permeable membrane can be connected in series such that the membrane separator permeate output contacts a second semi-permeable membrane. For example, as shown in FIG. 11, a membrane separator retentate input comprising the PFAS molecules, the liquid, and the surfactant enters a membrane separator and is transported across a semi-permeable membrane to form a membrane separator permeate output exiting the membrane separator. The membrane separator permeate output then enters another membrane separator as a membrane separator retentate input. The recycling of a portion of a membrane separator retentate output is also shown.

In some embodiments, two or surfactants are used. For example, as shown in FIG. 12, which is substantially the same FIG. 11 except that surfactant is introduced between each semi-permeable membrane (e.g., surfactant having the same composition and/or different compositions) and each membrane separator retentate output shown is recycled back into each respective semi-permeable membrane. In some embodiments, each surfactant can a particular set of contaminants (e.g., a first surfactant can be used to remove relatively large PFAS molecules and a second surfactant can be used to remove relatively small PFAS molecules).

In some embodiments, the system comprises a membrane separator comprising at least one semi-permeable membrane defining a permeate side of the membrane separator and a retentate side of the membrane separator, wherein the retentate side of the membrane separator is configured to receive a membrane separator retentate input comprising per- and/or polyfluoroalkyl substance (PFAS) molecules, a liquid, and a surfactant; and a foam fractionation separator, comprising: an inlet fluidically connected to the permeate side of the membrane separator and configured to receive a foam fractionation separator input; one or more outlets configured to: output a foam fractionated product output having a lower concentration of the PFAS molecules than the foam fractionation separator input, and output a foam fractionated recovery output, the foam fractionated recovery output comprising at least some of the PFAS molecules and at least some of the surfactant. For example, in FIG. 1A, system 100 comprises membrane separator 110 comprising at least one semi-permeable membrane 125 defining permeate side 120 of membrane separator 110 and retentate side 115 of membrane separator 110, wherein retentate side 115 of membrane separator 110 is configured to a membrane separator retentate input 160 comprising per- and/or polyfluoroalkyl substance (PFAS) molecules, a liquid, and a surfactant; and foam fractionation separator 130, comprising: inlet 165 fluidically connected to permeate side 120 of membrane separator 110 and configured to receive foam fractionation separator input 135; one or more outlets 170A-170B configured to: output foam fractionated product output 150 having a lower concentration of the PFAS molecules than foam fractionation separator input 135, and output foam fractionated recovery output 140, foam fractionated recovery output 140 comprising at least some of the PFAS molecules and at least some of the surfactant.

In some embodiments, the system comprises: a membrane separator comprising at least one semi-permeable membrane defining a permeate side of the membrane separator and a retentate side of the membrane separator, wherein the retentate side of the membrane separator is configured to receive a membrane separator retentate input comprising at least a portion of a foam fractionated recovery output comprising per- and/or polyfluoroalkyl substance (PFAS) molecules, a liquid, and a surfactant; and a foam fractionation separator, comprising: one or more inlets configured to: receive a foam fractionation separator input; and one or more outlets configured to: output a foam fractionated product output having a lower concentration of the PFAS molecules than the foam fractionation separator input, and output the foam fractionated recovery output. For example, in FIG. 2A, system 100, comprising: membrane separator 110 comprising at least one semi-permeable membrane 125 defining permeate side 120 of membrane separator 110 and retentate side 115 of membrane separator 110, wherein retentate side 115 of membrane separator 110 is configured to receive membrane separator retentate input 160 comprising at least a portion of foam fractionated recovery output 140 comprising per- and/or polyfluoroalkyl substance (PFAS) molecules, a liquid, and a surfactant; and foam fractionation separator 130, comprising: one or more inlets 165 configured to: receive foam fractionation separator input 135; and one or more outlets 170A-170B configured to: output foam fractionated product output 150 having a lower concentration of the PFAS molecules than foam fractionation separator input 135, and output foam fractionated recovery output 140.

In some embodiments, the method comprises: removing an amount of per- and/or polyfluoroalkyl substance (PFAS) molecules from a feed comprising a liquid and the PFAS molecules, wherein the removing comprises: transporting a membrane separator retentate input to a retentate side of a membrane separator, the membrane separator retentate input comprising at least a portion of the feed and a surfactant present such that at least some of the PFAS molecules are associated with a micelle comprising the surfactant, such that: a membrane separator retentate output exits the retentate side of the membrane separator, and at least a portion of liquid from the membrane separator retentate input is transported from the retentate side of the membrane separator, through a semi-permeable membrane of the membrane separator, to a permeate side of the membrane separator to form some or all of a membrane separator permeate output having a concentration of the PFAS molecules that is less than that of the membrane separator retentate input; wherein the membrane separator retentate input comprises at least a portion of the membrane separator retentate output, which comprises at least some of the PFAS molecules transported to the retentate side of the membrane separator. For example, in FIG. 3, the method comprises: removing an amount of per- and/or polyfluoroalkyl substance (PFAS) molecules from feed 105 comprising a liquid and the PFAS molecules, wherein the removing comprises: transporting membrane separator retentate input 160 to a retentate side 115 of membrane separator 110, membrane separator retentate input 160 comprising at least a portion of feed 105 and a surfactant present such that at least some of the PFAS molecules are associated with a micelle comprising the surfactant, such that: membrane separator retentate output 155 exits retentate side 115 of membrane separator 110, and at least a portion of liquid from membrane separator retentate input 160 is transported from retentate side 115 of membrane separator 110, through semi-permeable membrane 125 of membrane separator 110, to permeate side 120 of membrane separator 110 to form some or all of membrane separator permeate output 145 having a concentration of the PFAS molecules that is less than that of membrane separator retentate input 160; wherein membrane separator retentate input 160 comprises at least a portion of membrane separator retentate output 155, which comprises at least some of the PFAS molecules transported to retentate 115 side of membrane separator 110.

U.S. Provisional Patent Application No. 63/645,798, filed May 10, 2024, and entitled “Membrane-Based Separation of Micelle-Associated PFAS Molecules,” is incorporated herein by reference in its entirety for all purposes.

The following examples are intended to illustrate certain embodiments of the present invention, but do not exemplify the full scope of the invention.

### Example 1

This example describes the separation of PFAS from water.

To determine the effect of surfactant dosage on the removal of PFAS molecules in a feed using micelle-enhanced filtration, several different concentrations of surfactant were dosed into a feed, and the feed was filtered through an embodiment of a micelle-enhanced filtration (MEF) system, comprising an ultrafiltration membrane (e.g., zwitterionic semi-permeable membrane) having a membrane surface area of approximately 0.00006 m², to remove PFAS molecules. A foam fractionation separator was not used in this example. The removal efficiency of selected PFAS molecules was then calculated based on the concentration of the selected PFAS molecules in the feed and the concentration of the selected PFAS molecules in the permeate. In this experiment, a cationic co-surfactant, cetyltrimethylammonium bromide (CTAB), was added to feed water at a concentration of 200 mg/L. The feed water comprising the PFAS molecules and the surfactant was treated using the MEF system. Table 1 depicts the MEF removal efficiency of various PFAS molecules including perfluorooctanoic acid (PFOA), perfluorooctane sulfonic acid (PFOS), perfluorohexanesulphonic acid (PFHxS), perfluorobutane sulfonate (PFBS), and perfluorobutanoic acid (PFBA). The concentration of these compounds in the feed water and in the permeate are also shown in Table 1. PFAS molecules with relatively long chain lengths, including PFOA, PFOS, PFHxS, and PFBS, were removed from the feed water with efficiencies greater than or equal to 99.0%. However, PFAS molecules with relatively short chain lengths had lower efficiencies, such as PFBA which had a removal efficiency of 84%.

TABLE 1
Removal efficiency of MEF with 200 mg/L
co-surfactant dosage for PFAS molecules.

| | Feed (μg/L) | Permeate (μg/L) | Removal Efficiency |
|---|---|---|---|
| PFOA | 31.000 | 0.220 | 99.3% |
| PFOS | 15.000 | 0.140 | 99.1% |
| PFHxS | 26.000 | 0.160 | 99.4% |
| PFBS | 13.000 | 0.130 | 99.0% |
| PFBA | 15.000 | 2.400 | 84.0% |

To determine whether higher surfactant concentration improved removal efficiencies, a second set of experiments were performed in which the CTAB was added into the feed water at a relatively higher concentration of 350 mg/L. The feed water and the surfactant were treated in a similar manner using the MEF system. The removal efficiencies of the compounds and their concentrations in the feed water and in the permeate are shown in Table 2. PFAS molecules with relatively long chain lengths including PFOA, PFOS, and PFHxS exhibited removal efficiencies greater than or equal to 99.6% which is higher than observed with a CTAB dosage of 200 mg/L. However, those with relatively short chain lengths were not removed as efficiently. PFBS and PFBA had a removal efficiency of 98.8% and 83.7% respectively, which was lower than that observed with a CTAB dosage of 200 mg/L.

TABLE 2
Removal efficiency of MEF with 350 mg/L
co-surfactant dosage for PFAS molecules.

| | Feed (μg/L) | Permeate (μg/L) | Removal Efficiency |
|---|---|---|---|
| PFOA | 31.000 | 0.100 | 99.7% |
| PFOS | 15.000 | 0.050 | 99.7% |
| PFHxS | 26.000 | 0.100 | 99.6% |
| PFBS | 13.000 | 0.150 | 98.8% |
| PFBA | 15.000 | 2.450 | 83.7% |

A third set of experiments was performed in which the concentration of CTAB was further increased to 1000 mg/L, and the resulting feed water and surfactant was treated using the MEF system. The results are summarized in Table 3. These compounds, including PFBS and PFBA which experienced a decrease in removal efficiency with an increase in co-surfactant concentration from 200 mg/L to 350 mg/L, were removed with removal efficiencies greater than or equal to 98%. Surprisingly, PFAS molecules with relatively short chain lengths were removed with relatively high efficiencies under these conditions. PFBS and PFBA, specifically, exhibited removal efficiencies of 99.6% and 98.0%, respectively. Accordingly, based on the experimentation described herein, PFAS molecules, including those with relatively short chains length (e.g. PFBS and PFBA), can be effectively removed from feed water comprising the PFAS molecules with relatively high efficiencies using some embodiments of the systems and methods described within the totality of this disclosure.

TABLE 3
Removal efficiency of MEF with 1000 mg/L
co-surfactant dosage for PFAS molecules.

| | Feed (μg/L) | Permeate (μg/L) | Removal Efficiency |
|---|---|---|---|
| PFOA | 31.000 | 0.050 | 99.8% |
| PFOS | 15.000 | 0.050 | 99.7% |
| PFHxS | 26.000 | 0.050 | 99.8% |
| PFBS | 13.000 | 0.050 | 99.6% |
| PFBA | 15.000 | 0.300 | 98.0% |

### Example 2

This example described the separation of PFAS from water and the limited separation of ions (e.g., sulfate) from water.

Aqueous solutions comprising PFAS may also comprise relatively large quantities of ions, such as sulfate. However, such ions may scale on semi-permeable membranes and negatively impact the efficiency of downstream oxidation systems due to side reactions and/or less hydroxyl (OH) production. Accordingly, it may be desirable to use semi-permeable membranes and suitable surfactant concentrations to separate PFAS from a waste stream while limiting the separation of sulfate from the waste stream. It may be, in some instances, especially desirable for PFAS removal systems to remove PFBA, a small PFAS compound that is generally known to be difficult to separate from aqueous solutions, while limiting rejection of sulfate and/or other ions.

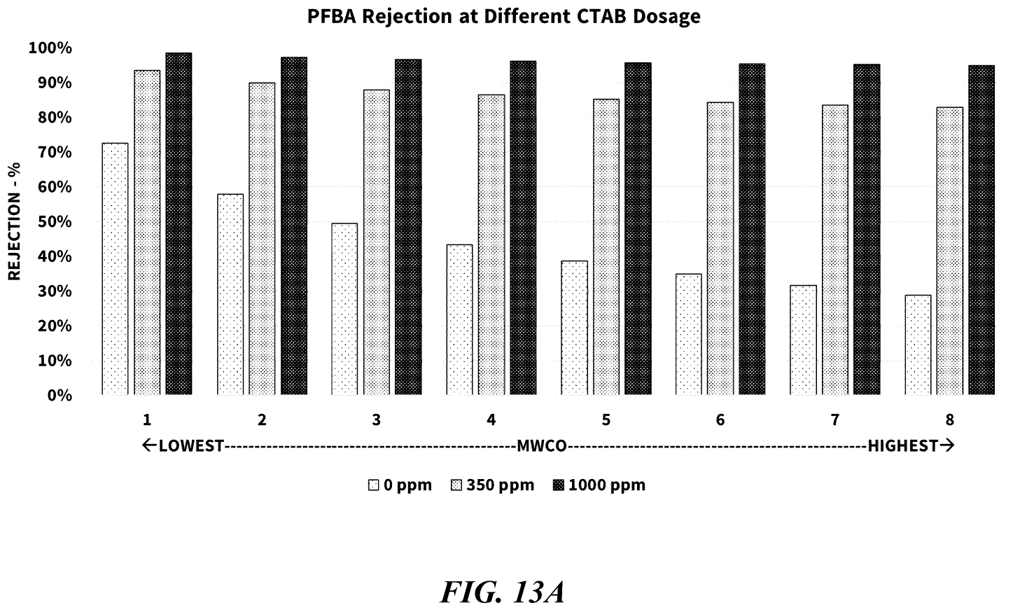

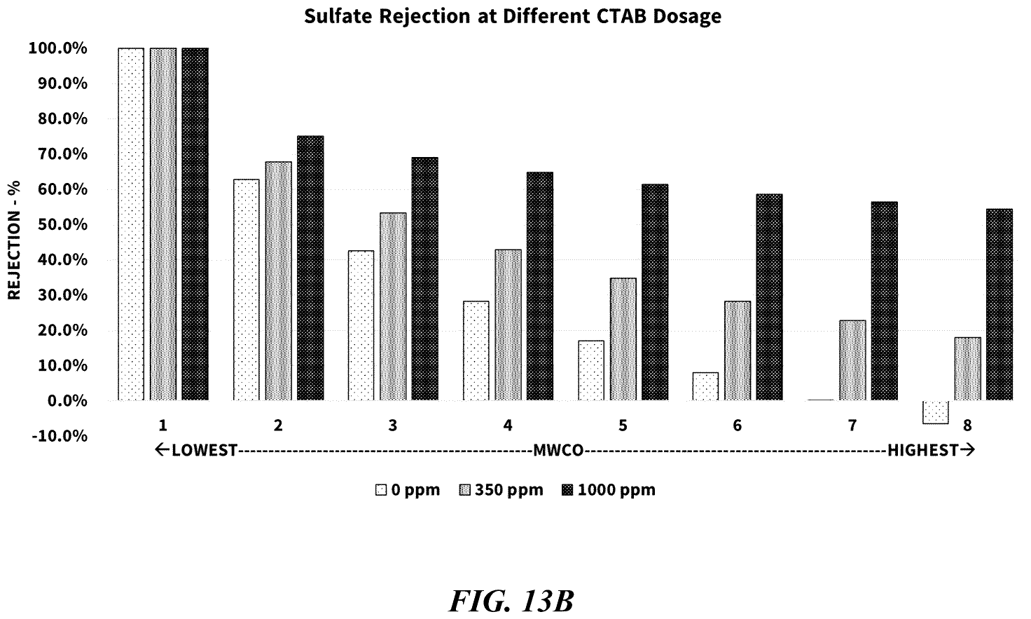

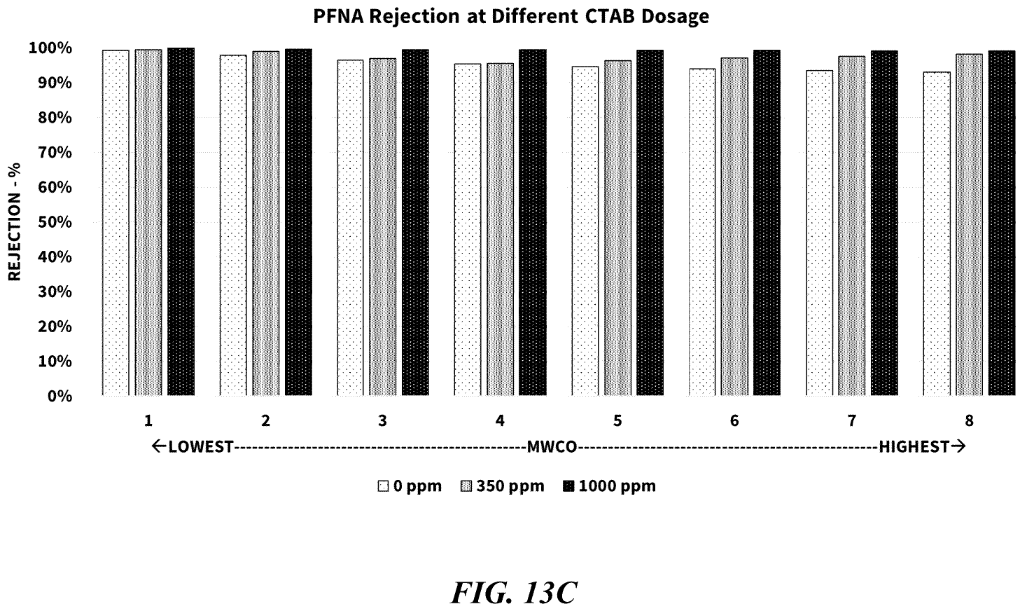

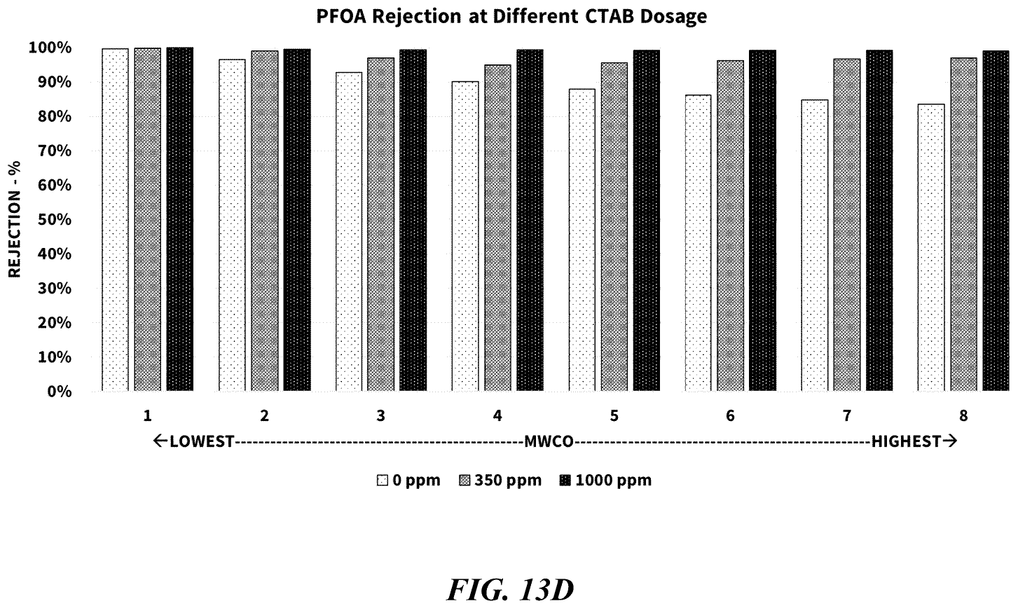

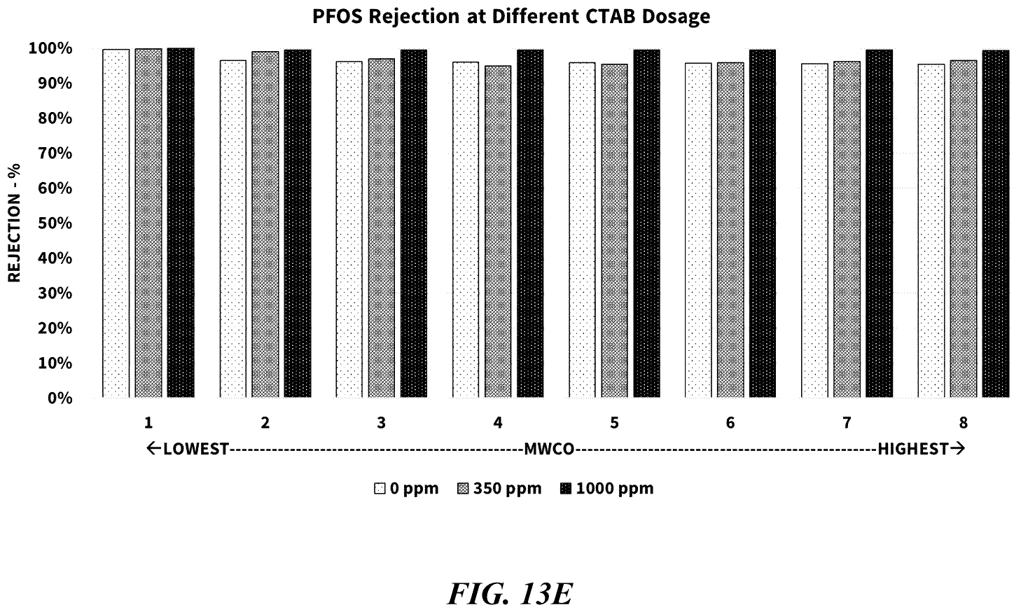

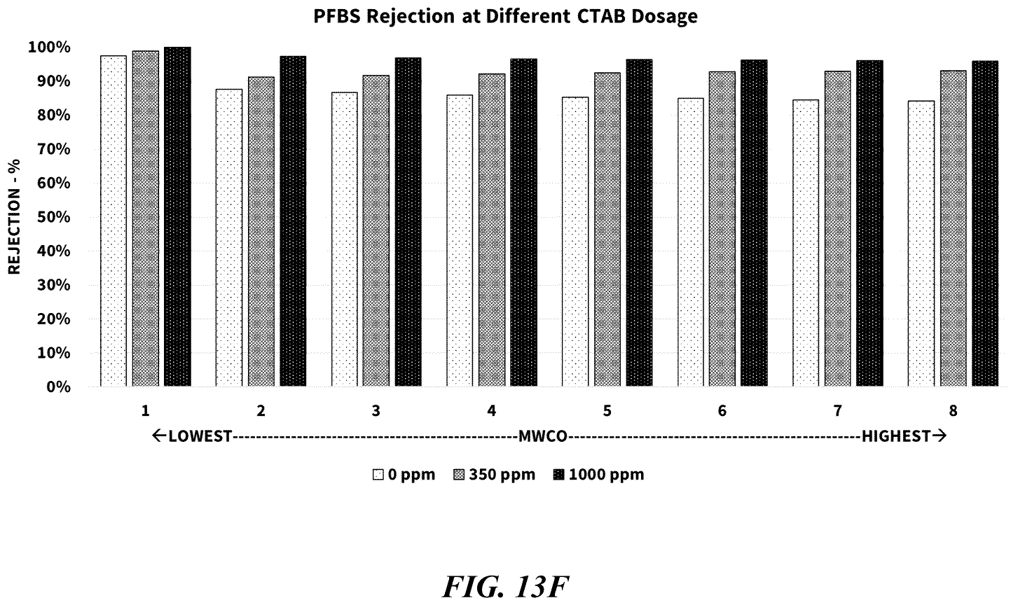

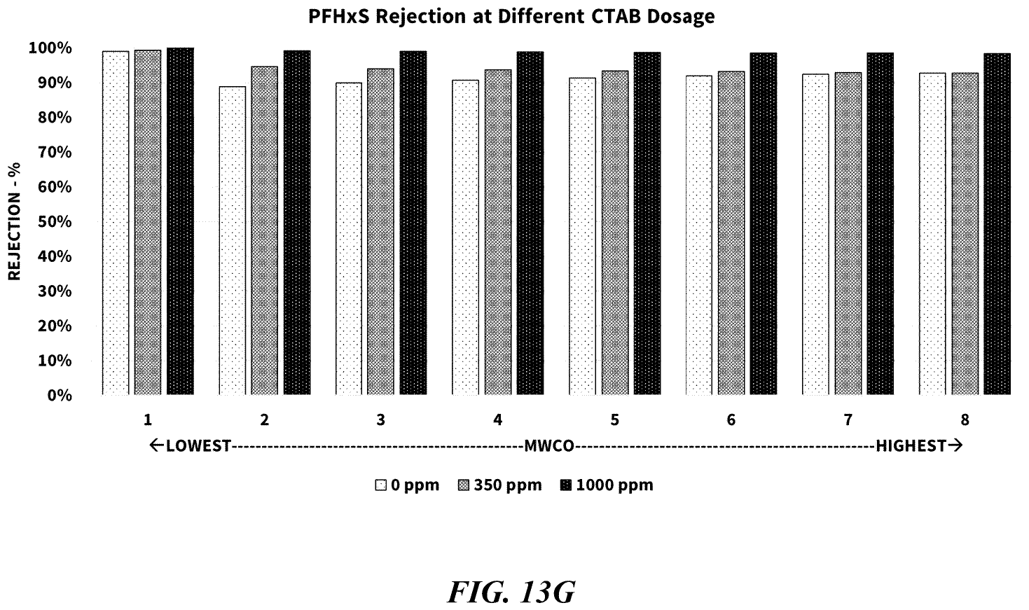

Semi-permeable membranes having various MWCO were tested to determine suitable MWCOs that facilitate desirable PFAS separation and limited ion separation. The MWCO of each tested semi-permeable membrane is shown in Table 4 and corresponds to the MWCO values shown on the x-axis of FIGS. 13A-13G. These tests were carried out at three different surfactant concentrations: 0 ppm, 350 ppm, and 1000 ppm. The surfactant used in this example was CTAB. After an aqueous solution comprising PFAS, CTAB, and sulfate ions derived from calcium sulfate (CaSO₄) was transported through the membrane separator having 2.5 inch membrane modules with a membrane area approximately between 2 m² to 3 m², the concentration of PFAS molecules and sulfate ions was determined, and the rejection percentages of each were calculated. To determine the dependence of the rejection percentage on the MWCO of the semi-permeable membrane, a logarithmic trendline was fit to each dataset, where each dataset represented tests conducted at a different surfactant concentration. To generate the logarithmic trendlines, the membranes of different MWCO were each assigned a numerical value from 1 to 8, with 1 corresponding to the lowest MWCO and 8 corresponding to the highest MWCO. These values were used as the independent variable (x) in the trendline fitting, with rejection percentages from the data used as the dependent variable (y) in the trendline fitting. Then, for each surfactant concentration, the logarithmic trendline was fit to the rejection percentage data using the equation of the form y=Aln(x)+B, where A and B were the coefficients to be fit, In is the natural logarithm, x was the membrane value discussed above, and y was the rejection percentage. The rejection percentage values shown in FIGS. 13A-13G result from the best fit curves from the trendline fitting and were calculated as a function of the MWCO of each semi-permeable membrane using the logarithmic equations generated from the fitting described.

The logarithmic trendline-fit rejection percentages of PFBA in the membrane separator permeate output is shown in FIG. 13A. The logarithmic trendline-fit rejection percentages of sulfate in the membrane separator permeate output is shown in FIG. 13B. As shown in FIGS. 13A-13B, PFBA is rejected by semi-permeable membranes having various MWCO ranges at rejection percentages greater than 60% at CTAB doses greater than or equal to 350 ppm while sulfate rejection is limited to below 60% rejection. The rejection percentages of other PFAS compounds, such as PFNA, PFOA, PFOS, PFBS, and PFHxS, was also tested under similar conditions. The logarithmic trendline-fit results of these tests are shown in FIGS. 13C-13G.

TABLE 4
MCWO values of semi-permeable membrane
tested in this example.

| Semi-permeable Membrane No. | MWCO (Da) |
|---|---|
| 1 | 150-300 |
| 2 | 200-400 |
| 3 | 1000 |
| 4 | 2000 |
| 5 | 3000 |
| 6 | 500-3000 |
| 7 | 4000 |
| 8 | 10000 |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system, comprising:
a membrane separator comprising at least one semi-permeable membrane defining a permeate side of the membrane separator and a retentate side of the membrane separator, wherein the retentate side of the membrane separator is configured to receive a membrane separator retentate input comprising per- and/or polyfluoroalkyl substance (PFAS) molecules, a liquid, and a surfactant; and
a foam fractionation separator, comprising:
an inlet fluidically connected to the permeate side of the membrane separator and configured to receive a foam fractionation separator input; and
one or more outlets configured to:
output a foam fractionated product output having a lower concentration of the PFAS molecules than the foam fractionation separator input, and
output a foam fractionated recovery output, the foam fractionated recovery output comprising at least some of the PFAS molecules and at least some of the surfactant.

2. A system, comprising:
a membrane separator comprising at least one semi-permeable membrane defining a permeate side of the membrane separator and a retentate side of the membrane separator, wherein the retentate side of the membrane separator is configured to receive a membrane separator retentate input comprising at least a portion of a foam fractionated recovery output comprising per- and/or polyfluoroalkyl substance (PFAS) molecules, a liquid, and a surfactant; and
a foam fractionation separator, comprising:
one or more inlets configured to:
receive a foam fractionation separator input; and
one or more outlets configured to:
output a foam fractionated product output having a lower concentration of the PFAS molecules than the foam fractionation separator input, and
output the foam fractionated recovery output.

3. A system, comprising:
a membrane separator comprising at least one semi-permeable membrane and configured to:
receive a membrane separator retentate input comprising per- and/or polyfluoroalkyl substance (PFAS) molecules, a surfactant, and a liquid; and
remove at least a portion of the PFAS molecules from the membrane separator retentate input.

4. The system of claim 1, further comprising a vessel comprising one or more inlets configured to receive a feed and/or the foam fractionated recovery output, an outlet fluidically connected to the retentate side of the membrane separator, and at least one inlet fluidically connected to the foam fractionated recovery output.

5-6. (canceled)

7. The system of claim 1, wherein the foam fractionation separator further comprises at least one inlet configured to receive a foam fractionation separator input from the permeate side of the membrane separator.

8. (canceled)

9. The system of claim 1, wherein the system comprises two or more membrane separators fluidically connected to each other.

10-13. (canceled)

14. The system of claim 1, wherein the membrane separator comprises a neutral-charged membrane.

15. The system of claim 1, wherein the membrane separator comprises a zwitterionic membrane.

16. The system of claim 1, wherein the membrane separator comprises a super-filtration membrane.

17. (canceled)

18. The system of claim 1, wherein the MWCO of the semi-permeable membrane is greater than or equal to 200 Da and less than or equal to 5000 Da.

19-21. (canceled)

22. A method, comprising:
removing an amount of per- and/or polyfluoroalkyl substance (PFAS) molecules from a feed comprising a liquid and the PFAS molecules, wherein the removing comprises:
transporting a membrane separator retentate input to a retentate side of a membrane separator, the membrane separator retentate input comprising at least a portion of the feed and a surfactant present such that at least some of the PFAS molecules are associated with a micelle comprising the surfactant, such that:
a membrane separator retentate output exits the retentate side of the membrane separator, and
at least a portion of liquid from the membrane separator retentate input is transported from the retentate side of the membrane separator, through a semi-permeable membrane of the membrane separator, to a permeate side of the membrane separator to form some or all of a membrane separator permeate output having a concentration of PFAS molecules that is less than a concentration of PFAS molecules in the membrane separator retentate input;
wherein the membrane separator retentate input comprises at least a portion of the membrane separator retentate output, which comprises at least some of the PFAS molecules transported to the retentate side of the membrane separator.

23. A method, comprising:
contacting a membrane separator retentate input comprising a liquid and per- and/or polyfluoroalkyl substance (PFAS) molecules associated with a micelle comprising a surfactant with a semi-permeable membrane, such that at least a portion of the PFAS is removed from the liquid and a membrane separator retentate output is formed.

24. The method of claim 22, wherein the membrane separator retentate input comprises at least a portion of the membrane separator retentate output.

25. The method of claim 22, wherein the membrane separator retentate input comprises at least a portion of a foam fractionated recovery output exiting a foam fractionation separator.

26. The method of claim 25, wherein a foam fractionation input entering the foam fractionation separator comprises at least a portion of a membrane separator permeate output.

27. The method of claim 22, wherein the membrane separator is configured to continuously output the membrane separator retentate output.

28. (canceled)

29. The method of claim 22, wherein the membrane separator is fluidically connected to a second membrane separator.

30-34. (canceled)

35. The method of claim 22, wherein a concentration of the surfactant in the membrane separator retentate input is greater than or equal to 100 mg/L and less than or equal to 1000 mg/L.

36. The method of claim 22, wherein a concentration of the surfactant in the membrane separator retentate input is greater than or equal to 200 mg/L and less than or equal to 360 mg/L.

37. The method of claim 22, wherein the molecular weight of the micelles is less than or equal to 3000 Da.

38. The method of claim 22, wherein a concentration of PFAS in the membrane separator permeate output is at least 90% lower than a concentration of PFAS in the membrane separator retentate input.

39. The method of claim 22, wherein the membrane separator retentate input comprises water.

40. The method of claim 22, wherein the membrane separator retentate input comprises dissolved sulfate and wherein the semi-permeable membrane permits for at least a portion of the dissolved sulfate to be transported from the retentate side of the membrane separator to the permeate side of the membrane separator.

41-42. (canceled)
